(19) United States
(12) Patent Application Publication
(10) Pub. No.: US 2005/0007444 A1
(43) Pub. Date: Jan. 13, 2005

(54) Information processing apparatus, information processing method, and software product

(75) Inventors: Masahiro Yamazaki, Yokohama (JP); Hideki Kuwamoto, Hujiwara (JP); Yuzo Okano, Yokosuka (JP)

Correspondence Address: McDermott, Will & Emery, 600, 13th Street, N.W., Washington, DC, 20005-3096, US

(73) Assignee: Hitachi, Ltd.

(21) Appl. No.: 10/886,727

(22) Filed: Jul. 9, 2004

(30) Foreign Application Priority Data
Jul. 9, 2003 (JP) 2003-194007

(51) Int. Cl. H04N 7/14

(52) U.S. Cl. 348/14.01

(57) ABSTRACT

An information processing apparatus comprises a camera that outputs picture information, a memory which stores concise information related to at least one string of one or more characters and a data communication interface for communication via a network. The information processing apparatus includes a CPU which recognizes a string of one or more characters included in picture information output by the camera and displays a result of recognition and the concise information related to the recognized string of one or more characters in response to a character recognition request by a user. The CPU also controls the data communication interface to communicate via a network and displays information received by the data communication interface, when the user requests detailed information related to the recognized string of one or more characters.

### TECHNICAL FIELD

The present invention relates to an information processing device such as a portable cellular phone, a personal handy-phone system (PHS), a personal digital assistant (PDA), a laptop or handheld personal computer (PC) or the like.

### BACKGROUND

Japanese Patent Laid-open No. 2002-252691 has disclosed a portable phone terminal capable of inputting printed information such as an address, a phone number and a URL (uniform resource locator) by using an OCR (optical character recognition) function. Japanese Patent Laid-open No. 5-274346 has disclosed an electronic dictionary having a character recognition part. The electronic dictionary recognizes a printed character string and displays the translations of the character string on a display part.

Generally, a memory capacity of the electronic dictionary is limited. Therefore, if a user wants to know more detailed information about the recognized character, the user needs another electronic dictionary or ordinary paper dictionary and has to look up the character in the dictionary again.

There is a need for an improved information processing apparatus.

### SUMMARY

The above stated need is met by an information processing apparatus that comprises a camera that outputs picture information, a memory which stores concise information related to at least one string of one or more characters and a data communication interface for communication via a network. The information processing apparatus includes a CPU which recognizes a string of one or more characters included in picture information output by the camera and displays a result of recognition and the concise information related to the recognized string of one or more characters in response to a character recognition request is by a user. The CPU also controls the data communication interface to communicate with the server and displays information received by the data communication interface, when the user requests detailed information related to the recognized string of one or more characters.

### BRIEF DESCRIPTION OF THE DRAWINGS

FIG. 1 is a block diagram showing the configuration of an information processing apparatus;

FIG. 2 shows an example of the contents of dictionary data;

FIG. 3 shows an example of the contents of dictionary data;

FIG. 4 is a flowchart describing a procedure of an information processing apparatus

FIG. 5 shows examples of display screen images;

FIG. 6 shows examples of display screen images;

FIG. 7 shows an example of a history table;

FIG. 8 is a flowchart describing a process of creating a history table;

FIG. 9 shows examples of display screen images

FIG. 10 is a flowchart describing a process of downloading character pattern data;

FIG. 11 shows examples of display screen images that appear during downloading of character pattern data;

FIG. 12 illustratively shows an example in which the information processing apparatus accesses a dictionary provider

FIG. 13 is a flowchart describing a process to access a Web site;

FIG. 14 shows the appearance of an information processing apparatus;

FIG. 15 is a flowchart describing a procedure to be executed in the information processing apparatus;

FIG. 16 shows examples of display screen images;

FIG. 17 shows examples of display screen images;

FIG. 18 shows examples of display screen images;

FIG. 19 shows an example of system for searching an appropriate definition;

FIG. 20 shows an example of a relationship-of-co-occurrence database;

FIG. 21 is a flowchart describing a procedure to be executed in an information processing apparatus;

FIG. 22 is a flowchart describing a procedure to be executed in a server;

FIG. 23 is an explanatory diagram concerning the positional relationship among a recognition object word and co-occurring words;

FIG. 24 describes an exemplary sequence of transactions performed by an information processing apparatus and a server; and

FIG. 25 shows examples of display screen images.

### DETAILED DESCRIPTION

A description of an information processing apparatus such as a cellular phone, a PHS, a PDA and a laptop or handheld personal computer will be made in conjunction with the drawings below. In the drawings, the same reference numerals will be assigned to identical components.

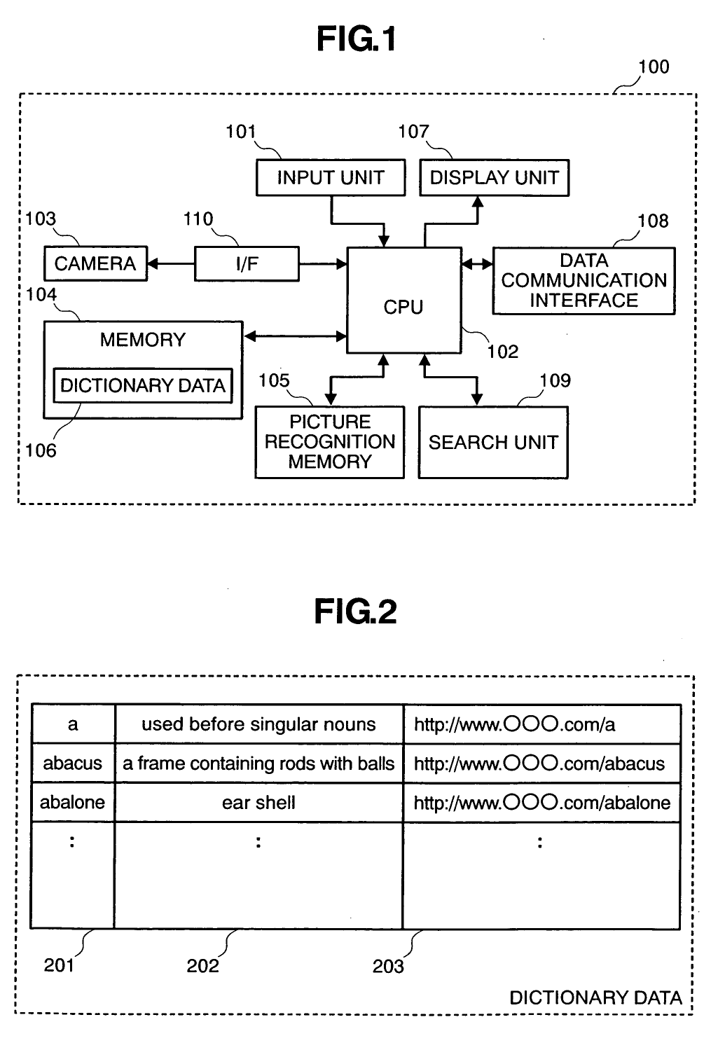

FIG. 1 is a block diagram showing an example of the configuration of an information processing apparatus. The information processing apparatus has an image recognition (OCR) function. A description will be made of a case where the image recognition function is used to recognize a word printed on a paper or the like and definitions of the word are provided on a display.

An input unit 101 comprises a keyboard that has a plurality of keys including a shutter button, a power button, and numerical keys. A user operates the input unit 101 to enter information such as a telephone number, an email address, a power supply ON/OFF command, and an image-taking command requesting a camera 103 to take a picture or the like. The input unit 101 may comprises a touch-sensitive panel type allowing a user to enter information or a directive by touching the screen of a display using a pen or his/her finger. Otherwise, a voice recognition unit may be included in order to adopt a voice recognition-based entry method.

A central processing unit (CPU) 102 controls components of the information processing apparatus by execution of a program stored in a memory 104. A camera 103 converts an optical image of an object that is a human being, scenery, or characters, into picture information conformable to, for example, a YUV standard, and transfers the picture information via a pictuire interface 110 to the CPU 102. Herein, the picture information conformable to the YUV standard is information containing a luminance signal (Y), a difference (U) between the luminance signal and a red color component, and a difference (V) between the luminance signal and a blue color component. However, the picture information converted by camera 103 is not limited to the one conformable to the YUV standard, but may be information conformable to any other standard as long as the CPU 102 can treat the picture information. In this example, the camera 103 is built in the information processing apparatus. This invention is not limited to this example. The camera may be external and attached to the information processing apparatus through the picture interface 110.

The CPU 102 converts the picture information conformable to the YUV standard into picture information conformable to the RGB (Red Green Blue) standard, and transmits the converted picture information to a display 107 or the like. A user selects an object or subject, of which image he/she wants to produce, while monitoring the picture information displayed on the display 107, and directs imaging using the shutter button or the like. When the shutter button is pressed, picture information sent from the camera 103 is stored in the memory 104. The memory 104 is, for example, a read-only memory (ROM) or a random access memory (RAM). Image data or voice data as well as software based on which the CPU 102 acts is stored in the memory 104.

A picture recognition memory 105 stores a software program to be executed for an OCR function by the CPU 102. The OCR function is a function for recognizing one or more characters such as a letter, a sign, a symbol, a mark, a number, and identification information or the like included in a picture. The identification information is, for example, an address of a home page, an email address, a post address, a telephone number, map information The identification information is not limited to these examples but may be any information with which an entity can be identified.

The recognition of a string of one or more characters comprises the steps of identifying a place that includes string of one or more characters from a picture taken by the camera 103, dividing the image data for the portion containing characters into predetermined portions, converting each of the data for the portions into a parameter value and determining what information is included in each of the portions on the basis of the parameter value.

As an example, recognition of characters ‘abc’ included in a picture is explained. First of all, the place at which the characters ‘abc’ are included in the picture is identified. Then, the image data for the portion containing characters ‘abc’ are split into portions containing characters ‘a’, ‘b’ and ‘c’. The data for portions contains characters ‘a’, ‘b’ and ‘c’ are converted into respective parameter values. The predetermined parameter values are determined in such a manner that: for example, a character is regarded as a combination of lengthwise, sideways, and oblique segments; a white portion of the character is represented with 0; and a black portion thereof is represented with 1. For each portion, a character most resembling the parameter value is selected among characters included in character pattern data. The character pattern data is data associating each parameter value with a character such as an alphanumeric character corresponding to the parameter value. The character pattern data may be stored in the memory 104 in advance or downloaded or installed by the user.

In this example, a memory dedicated for a picture-processing software is provided as the picture recognition memory 105. As an alternative, picture-processing software may be embedded in the CPU 102 or the memory 104 to provide the CPU 102 with an OCR function. By embedding the picture-processing software in the CPU 102 or the memory 104, the number of components may be reduced and the manufacturing cost and the like may also be decreased as well.

In this example, in order to shrink the circuit scale, the CPU 102 executes the OCR function. However, the configuration of the present invention is not limited to this example. For example, a dedicated processor can be used for implementing the OCR function.

An image produced by the camera 103 or a string of one or more characters recognized by the CPU 102 is displayed on the display 107. For example, an operating state such as the state of the power supply, the intensity of an electric wave, the amount of power remaining in a battery, the connected state of a server, or a list of unread mails is displayed on the display 107. A telephone number, an email address, or a document to be transmitted by email is displayed on the display 107. Moreover, a motion picture and a still image, an originator's telephone number at the time of call termination, a document terminated as a mail, or a Web page on the Internet is displayed on the display 107. However, a destination to which information such as identification information is transmitted is not limited to the display 107. The information may be presented by voice to be radiated from a loudspeaker. A data communication interface 108 performs communication with a server or a host computer of an information provider or any other data device via a network. The data communication interface 108 may be a modem or a network card or the like.

A search unit 109 is a processor, which references dictionary data 106 stored in the memory 104 to search for information corresponding to string of one or more characters recognized by the CPU 102.

FIG. 2 shows an example of the dictionary data 106. Words are recorded in a column 201, and concise definitions of the words recorded in the column 201 are recorded in a column 202. URLs assigned to home pages that carry pieces of information relevant to the words recorded in the column 201, for example, pieces of detailed information such as examples of use of the words are recorded in a column 203. In this example, the dictionary data 106 is data of an English-English dictionary. The memory 104 may store a plurality of dictionary databeses such as an English-Japanese dictionary, an English-French dictionary, an English-German dictionary, a science dictionary, and a sports dictionary. For example, when the English-Japanese dictionary is selected and an English word is recognized, the Japanese translation is recalled from the column 202 for display to the user.

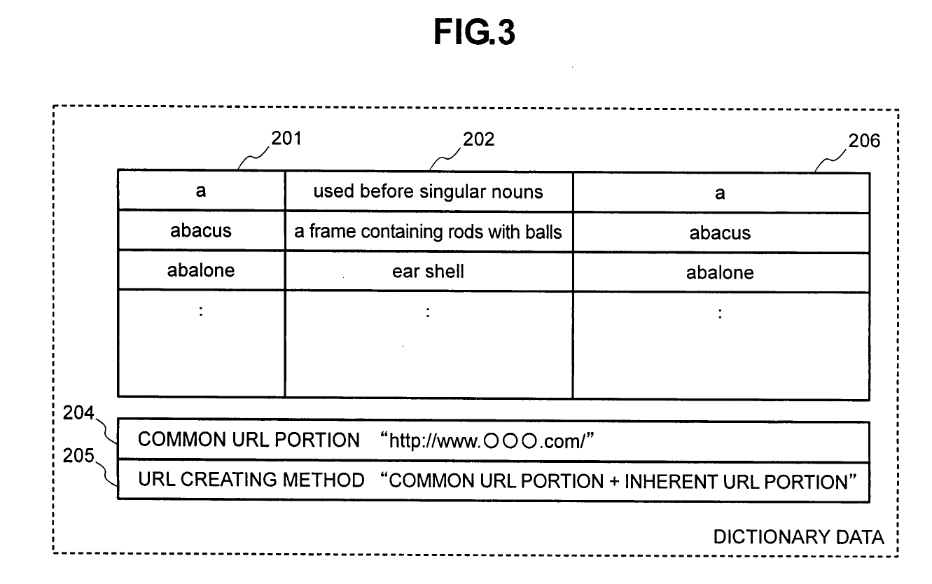

In the column 203, as shown in FIG. 3, part of each URL may be recorded. In this example, since “http://www.ooo.com” is used in common, this common portion is recorded in the field of a common URL portion 204. An inherent URL portion such as “a” or “abacus” is recorded in a column 206 as an inherent URL portion. Moreover, a method of creating an URL of a home page, which carries detailed information, by combining the common URL portion 204 and inherent URL portion 206 is recorded in the field of a URL creating method 205. When URLs are recorded as mentioned above, the data size of the dictionary data 106 can be decreased. If the pieces of information recorded in the column 206 are identical to the words recorded in the column 201, the column 206 may be omitted. Thus, the data size of the dictionary data can be further decreased. Moreover, data to be recorded in the dictionary data 106 is not limited to word definitions and/or translation data but may be terminology relevant to science or sports.

In this example, a processor dedicated for a search of dictionary data is provided as the search unit 109. However the present invention is not limited to this example, the CPU 102 may execute the search in order to shrink the circuit scale.

A description will be made of a case where there are two image-taking modes, i.e., an ordinary image-taking mode of taking a normal still picture or motion picture of a human being and scenery or the like as an ordinary camera function, and a recognition mode of taking a picture. When a user selects either of the modes, a mode determination flag which the CPU 102 checks to determine a selected image-taking mode is stored in the memory 104. The mode determination flag is a variable described in a program included in the software stored in the memory 104, and set to a value that is differentiated between the recognition mode and ordinary image-taking mode. Based on the variable, the CPU 102 switches the recognition mode and ordinary image-taking mode.

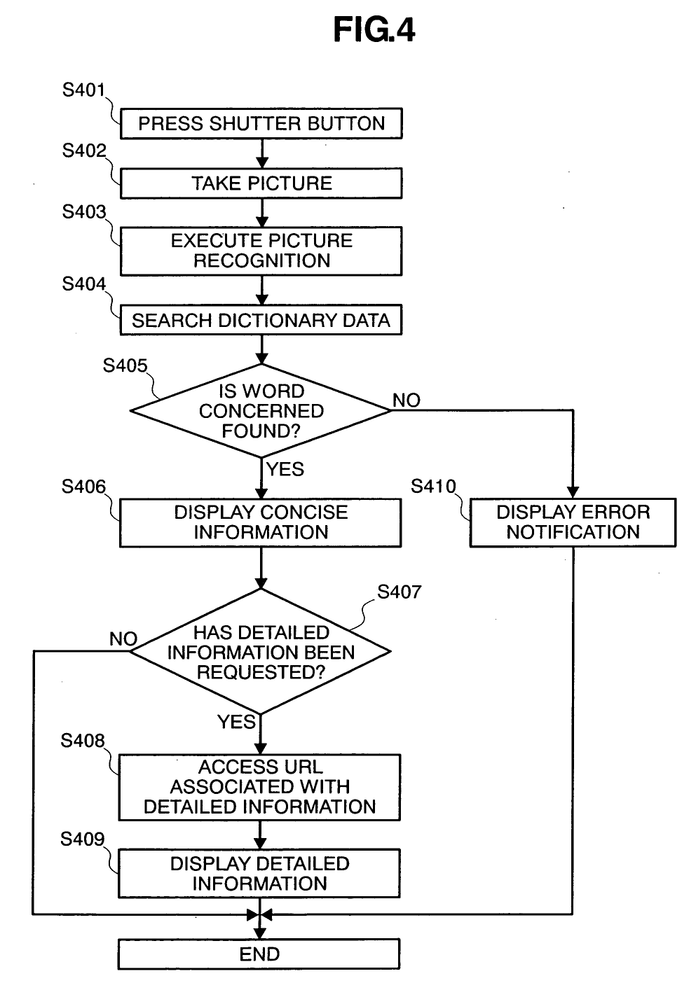

Next, an example of a procedure to be executed when the recognition mode is selected will be described in conjunction with the flowchart of FIG. 4. When a user presses the shutter button included in the input unit 101, the CPU 102 directs the camera 103 to take a picture (step S401). Picture information produced (converted) by the camera 103 is preserved in the memory 104 via the CPU 102 (step S402).

The CPU 102 reads the preserved picture information from the memory 104, recognizes string of one or more characters contained in the picture information, for example, a word “recognition” contained in a book. The CPU 102 preserves the result of recognition in the memory 104 (step S403).

The search unit 109 reads the result of recognition, and searches the words recorded in the column 201 of the dictionary data 106 stored in the memory 104 for a consistent word (step S404). If a correct matching word is found for the recognized string of one or more characters (step S405), concise information in the column 202 associated with the word is displayed on the display 107 (step S406) A preferable search method will be described. Namely, first, a fully consistent word is searched for. If the fully consistent word is not found, a word composed of characters one of which is different but the others of which are consistent is searched for. When this method is adopted, even if the CPU 102 incorrectly recognizes string of one or more characters in a paper, a word most closely resembling the character string can be found. Consequently, the labor for repeatedly producing an image and resuming character string recognition can be saved. This will prove user-friendly.

Moreover, if a word composed of characters one of which is different is not found, a word composed of characters two of which are different or three of which are different may be searched for, that is, a word may be searched for with the number of different characters increased gradually. Thus, even when a recognition rate is low, a correct word can be searched for.

The CPU 102 judges whether the user has requested detailed translation information through the input unit 101 (step S407). If the request is made, the CPU 102 reads a URL associated with the word retrieved by the search unit 109 at step S404, and transmits a directive signal to the data communication interface 108 so as to access the URL (step S408). The display 107 displays information received via the data communication interface 108, such as the contents of the home page or the like. If a correct word is not found (step S405), a notification that no word was found is presented to a user through the display 107 (step S410). The procedure is then terminated.

As mentioned above, when a user wants to acquire not only a concise information but also a detailed information, a home page or the like carrying the detailed information can be displayed. The user may know the detailed information of a word or the like without the necessity of looking up the word in a dictionary. This will prove user-friendly.

An information processing apparatus may not afford a large-capacity memory. Namely, minimum necessary information alone such as concise definition or typical translation is stored in the information processing apparatus. When a user wants detailed information, the user acquires information from a server of an information provider through a network. Therefore, the method employed in this example may be quite effective.

In this example, the concise information and the detailed information are provided for the user on demand. However, this invention is not limited to this example. Two different types of information, a first information and a second information, may be provided from the memory and via the network respectively.

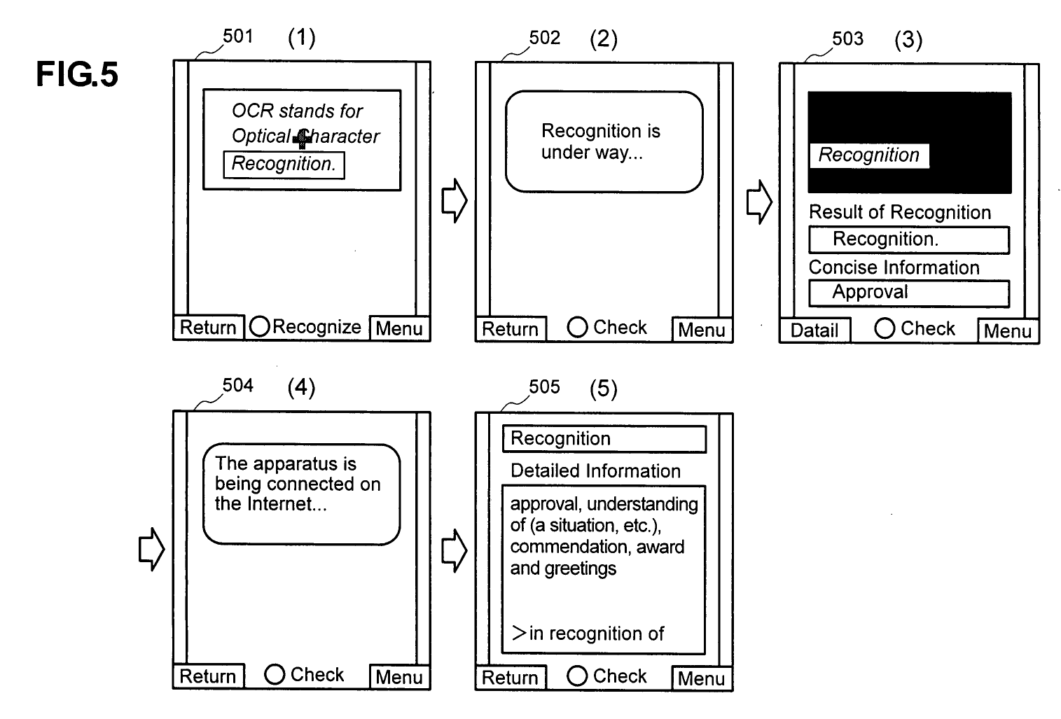

FIG. 5 shows examples of display screen images. Incidentally, the indications including an indication Menu contained in the lower part of each screen image are associated with key buttons included in the input unit 101. When a user presses a key button or the like, a display screen image provided by the feature of Menu or the like appears on the display 107. Every time the display screen images are switched, the key buttons are used to execute features associated with the indications contained in the lower part of each display screen image. Hereinafter, the key buttons shall be called by the names of the features associated with the displayed indications. For example, a key button associated with the Menu feature shall be called a Menu button, and a key button associated with a Return feature shall be called a Return button. The features associated with the indications may be assigned to key buttons according to the positions at which the indications are displayed, such as, the right lower position and left lower position. Alternatively, the features may be assigned to one key button.

A screen image 501 is an example of a screen image through which a user defines a range of picture recognition. For example, the user takes a mark such as ‘+’, ‘?’, ‘?’ or the like appearing in the center of the display 107 to a position near character string. In this case, the display 107 is used as a viewfinder. Otherwise, a user may operate the input unit 101 to move a cursor on the display to designate a range of recognition. Moreover, the user may be able to select any of a plurality of methods of determining an object of recognition. In the case of a motion picture, still images expressing frames constituting the motion pictures are produced so that the frames can be sequentially fed. Through a frame feed screen image in which the frames can be sequentially fed, an object of recognition may be designated.

The object of recognition may be encircled with a dot line or the like and thus distinguished. Alternatively, an enlarged or reduced image the object of recognition may be displayed. For enlargement, characters that are previously displayed in, for example, the form of one pixel sideways and one pixel lengthwise are displayed in the form of two pixels sideways and two pixels lengthwise. Furthermore, the image edit unit may change the color of an image portion containing string of one or more characters that are an object of recognition into black and white or sepia. Otherwise, the image portion may be highlighted and then displayed. The present invention is not limited to the above method of distinguishing an object of recognition. Any other method will do as long as an object of recognition contained in an image can be clearly identified.

In order to switch a wait screen image to the screen image 501, for example, a recognition mode button may be pressed. Otherwise, a menu screen image may be designated in the wait screen image, and a button contained in the menu screen image may be pressed in order to display the screen image 501. If a Recognize button contained in the lower part of the screen image is pressed with the screen image 501 displayed, the screen image 501 is switched to a screen image 502.

When the user presses the shutter button or the Recognize button, the screen image 502 is displayed on the display 107. The screen image 502 is a screen image for informing the user that a recognition process is being carried out. When recognition is terminated, the screen image 502 is switched to a screen image 503.

The screen image 503 appearing on the display 107 contains the result of recognition performed by the CPU 102 and a concise information associated with the result of recognition. An image portion other than the recognition object is displayed in, for example, black in order to distinguish the recognition object.

If a user wants to learn the meanings of the word or the usage thereof in detail, the user presses a button associated with presentation of a detail and contained in the left lower part of the screen image 503. Consequently, the screen image 503 is switched to a screen image 504. The screen image 504 indicates that the data communication interface 108 is connecting the information processing apparatus to a URL recorded in the column 203. When the information processing apparatus is connected to the URL recorded in the column 203, the screen image 504 is switched to a screen image 505. The screen image 505 presents detailed information such as contents of a home page located at the URL.

By utilizing the foregoing way for display information, after a user know concise information, once the user performs simple manipulation, the user can know detailed information of the word or the like. This may prove user-friendly.

Furthermore, in this example, one URL is used to look up the detailed information . The present invention is not limited to this form. For example, a plurality of URLs may be stored in a column 203. When detailed information is requested, any of the URLs may be able to be selected. In this case, a user can select any of numerous information sources to learn the detailed information of a word or the like, and will find it user-friendly.

Furthermore, in this example, a URL or the like is adopted as information to look up detailed information. The present invention is not limited to this form. As long as detailed information of a word or the like can be acquired, any form will do.

The detailed information acquired by using URL or the like may be stored in the memory 104. In this case, concise translations and detailed translations are stored while being distinguished from each other. If a user requests detailed information of the same word again, the detailed information is read from the memory 104 and then displayed. Consequently, detailed information can be displayed quickly because it is unnecessary to access the internet or the like. Eventually, wasted time can be saved. Moreover, detailed information can be acquired even if the portable cellular phone is located outside a communication-enabled sphere.

Moreover, other apparatus such as a personal computer or a storage in which detailed information is stored may be used to acquire detailed information. In this case, connection information required to read detailed information from other apparatus is recorded in the column 206 of the dictionary data 106. The connection information is, for example, an identifier of other apparatus such as an IP address, a pathname or a filename assigned to a file containing detailed information, or an address in a memory included in the other apparatus at which detailed information is stored.

For example, when a user wants detailed information of a string of one or more characters, the user uses a display screen image like the example shown in FIG. 5(3) to issue a request for detailed information. The CPU 102 having received a request signal transmits the connection information associated with the character string stored in the memory 104, to other apparatus such as PC via the data communication interface 108. Based on the connection information, the PC transmits detailed information, which is stored in a memory of the apparatus or an external memory, to the information processing apparatus. The information processing apparatus displays the detailed information on the display 107. A means for linking the information processing apparatus and the other apparatus may be a cable or a radio wave. If a cable is used for linking other apparatus, even when the information processing apparatus is located outside a communication-enabled area, detailed information can be acquired. This will prove user-friendly. Moreover, detailed information may also be able to be acquired from a storage medium in which detailed information is stored. In this case, a storage medium reader for reading information from the storage medium is included in the information processing apparatus, and the same procedure as the aforesaid one is executed.

Moreover, a user may be allowed to create or edit detailed information by himself/herself. In this case, a setting screen image through which the user creates or edits (adds or deletes) detailed information is displayed on the display 107. Entered information is recorded in the column 203 of the dictionary data. An original dictionary unique to a user can be created or edited. Furthermore, the created original dictionary may be used to acquire detailed information on a word. Information may be added to or deleted from predefined detailed information. Thus, user-friendliness further improves.

In this example, when concise information is needed, information stored in the memory 104 is utilized. Even when concise information is acquired, the information stored in other appatatus or storage medium, or the information received from the Internet may be utilized.

Next, procedure of operating the information processing apparatus when the memory 104 stores a plurality of dictionary data will be explained.

The memory 104 stores a plurality of dictionary data such as an English-English dictionary, an English-Japanese dictionary and a German-Japanese dictionary, and a dictionary flag.

The dictionary flag is a flag employed in designating which of the dictionary data items the CPU 102 uses. The dictionary flag is, for example, a variable contained in a program included in software stored in the memory 104. The value of the dictionary flag is made variable depending on the user's manipulation performed on the input unit 101. Thus, the user can acquire the translation of a word of any of many languages, and will find it user-friendly.

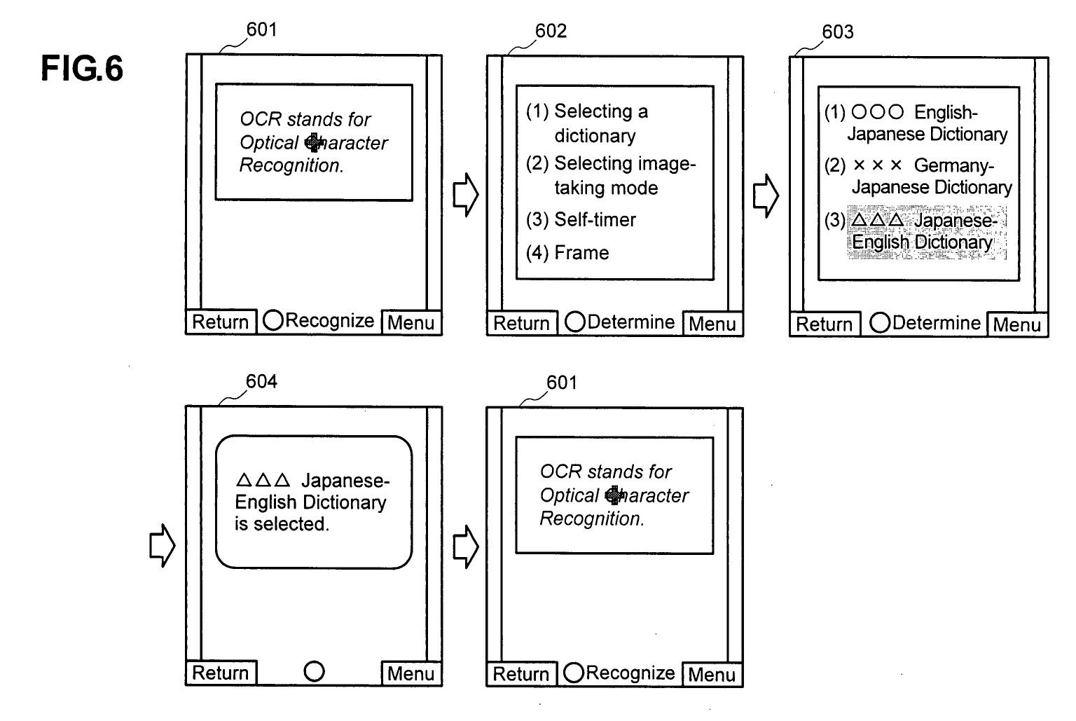

FIG. 6 shows examples of display screen images appearing on the display 107 when a user selects a dictionary to be employed. A screen image 601 is displayed when the camera 103 is activated in the recognition mode. In order to activate the camera 103, for example, a switch disposed on the flank of the information processing apparatus is pressed. Otherwise, a wait screen image is switched to a menu screen image, and buttons are pressed several times. In the screen image 601, a button associated with Menu appearing in the right lower part of the screen image is pressed. The screen image 601 is then switched to a screen image 602.

The screen image 602 is used to select a menu that lists menu items If a menu item “(1) Selecting a dictionary” is selected using the input unit 101, the screen image 602 is switched to a screen image 603.If a menu item “(3) ΔΔΔ Japanese-English dictionary” is selected using the input unit 101, the screen image 603 is switched to a screen image 604.

The screen image 604 notifies a user that the ΔΔΔ Japanese-English dictionary has been selected as a dictionary to be employed. At this time, if a button associated with Check is pressed, the screen image 604 is switched to a screen image 601. When the information processing apparatus holds a plurality of dictionary data items, a user may acquire information related to multiple languages. This will prove user-friendly.

Assuming that an English-Japanese dictionary is designated as dictionary data to be employed, if a German word is recognized, a consistent word is unfound. If the consistent word is unfound in the designated dictionary, the CPU 102 may switch the dictionary data from the English-Japanese dictionary to other dictionary data automatically. If the consistent word is unfound in the second dictionary data, the CPU switches to the third or the forth dictionary data. In this case, a user is relieved of the labor of selecting dictionary data. A user-friendly dictionary function can be realized.

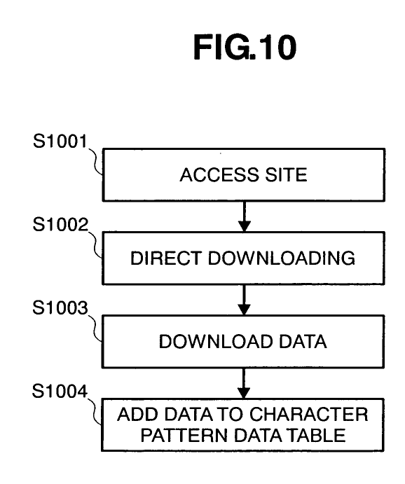

Referring to the flowchart of FIG. 10, the procedure according to download character pattern data from the Internet will be described below. For example, the picture recognition memory 105 stores only a software program for recognizing alphanumeric characters, the user cannot user the OCR function to recognize other character such as Chinese character or Arabic character. In order to solve this problem, the information processing apparatus communicates with a server or a host computer of an information provider via a network by the data communication interface 108 in order to download a software program including character pattern data.

First, the CPU 102 having been directed to download a character pattern data table accesses a Web site on the Internet, at which the character pattern data is preserved, via the data communication interface 108 (step S1001). With a Web page held at the Web site displayed, a user presses a button included in the input unit 101 so as to direct download of character patterns (S1002). Accordingly, the CPU 102 downloads character pattern data from the Web site via the data communication interface (step S1003).The CPU 102 adds the character pattern data to the character pattern data table in the picture recognition memory (step S1004).

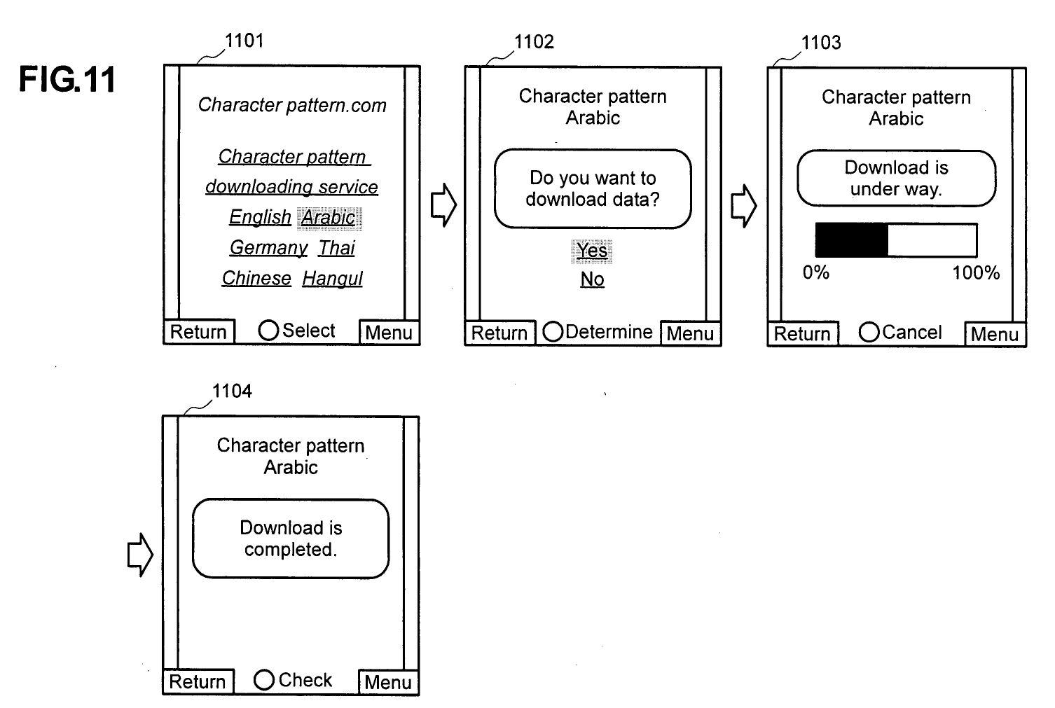

FIG. 11 shows examples of screen images through which the information processing apparatus is connected on a Web site, from which character pattern data can be downloaded.

A screen image 1101 presents a Web page preserved at a Web site on the Internet from which character patterns can be downloaded. For example, “Arabic” is selected, the screen image 1101 is switched to a screen image 1102. The screen image 1102 shows a user confirmation information if the user wants to download the Arabic character pattern data. If “Yes” is selected, the screen image 1102 is switched to a screen image 1103. The screen image 1103 indicates that the Arabic character patterns are being downloaded. When download is completed, the screen image 1103 is switched to a screen image 1104. The screen image 1104 indicates that the Arabic character patterns have been downloaded. Likewise, dictionary data representing character patterns of any other foreign language may be downloaded.

As mentioned above, since character pattern data items and dictionaries of various languages can be downloaded, characters of multiple languages can be recognized and related information such as translations of multiple languages can be acquired. This leads to improved user-friendliness.

When an attempt is made to recognize a character other than those represented by character pattern data items stored in the picture recognition memory 105, a user may be notified of the fact that the character cannot be recognized. Moreover, a screen image prompting the user to download character pattern data and dictionary data may be displayed on the display 107. Consequently, even when neither character pattern data nor dictionary data is stored in the picture recognition memory 105 or the memory 104, a charactermay be recognized and related information may be displayed. Thus, user-friendliness improves.

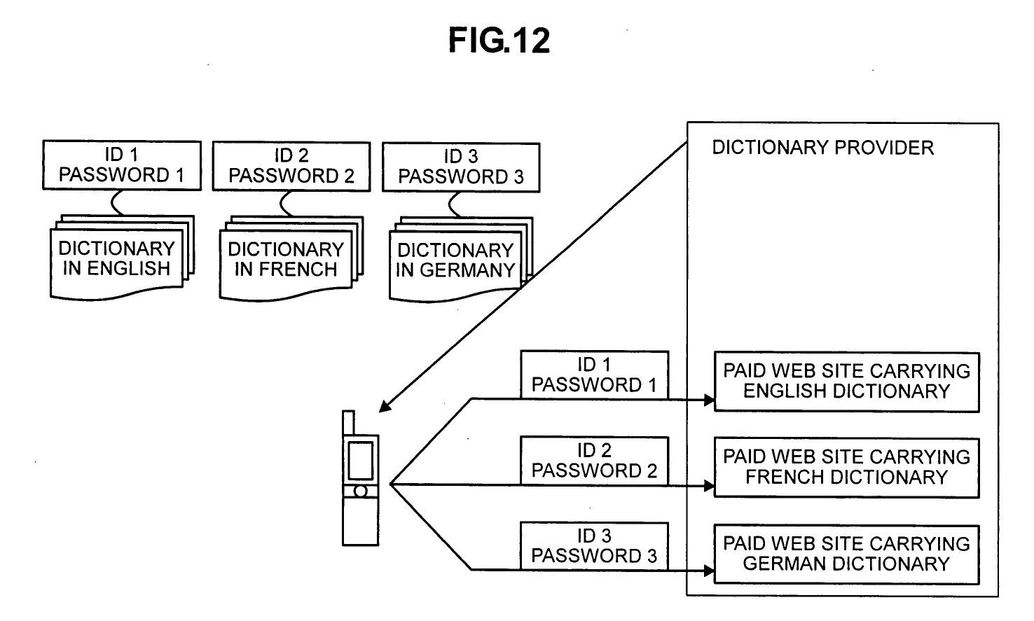

Alternatively, dictionary data may not be downloaded into the information processing apparatus but dictionaries on the Internet may be browsed. Many Web sites on the Internet provide home pages carrying a dictionary data. When related information is requested, the Web sites whose Web pages can be browsed by registered users alone may be introduced. In this case, every time a user requests related information, the user has to enter his/her user ID and password. This is not user-friendly. Therefore, a user ID and a password are recorded in the memory 104. FIG. 12 is diagrammatic illustration to show a case where the information processing apparatus access Web site carrying dictionary using a ID and a password stored in the memory 104. In this example, each ID and password are associated with each dictionary date.

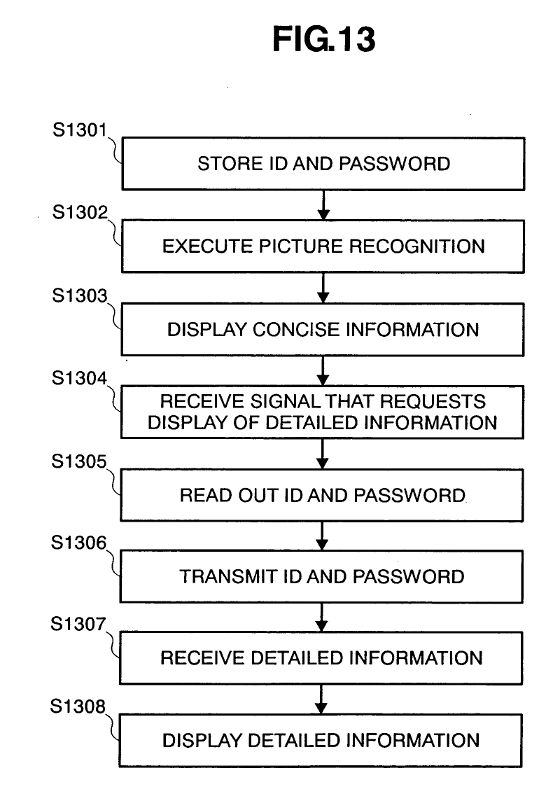

FIG. 13 is a flowchart describing a process to access a web site, which carries detailed information, using dictionary data.

At step S1301, a information processing apparatus acquires an ID and a password to access a restricted Web site. The ID and the password may be downloaded via the data communication interface 108, installed from a storage medium, or inputted by using input unit 101. The ID and the password are stored in the memory 104. For example, the ID and the password are written in a header of the dictionary data 106.

String of one or more characters are recognized (step S1302). Concise information is read out from the memory and displayed (step S1303).

If the CPU 102 receives a signal with which display of a detailed information is requested (step S1304), the CPU 102 reads out the user ID and the password from the memory 104 At step S1306, the CPU 102 transmits an access signal, the user ID and password to the server via the data communication interface 108. The server having received the access signal, user ID, and password authenticates a user. If the authentication succeeds, detailed information is transmitted to the information processing apparatus.

At step S1307, the information processing apparatus receives the detailed information via the data communication interface 108. At step S1308, the display 107 displays it.

As mentioned above, a user ID and a password are stored in the memory 104 and transmitted it to a server. Therefore, the user need not to enter the ID and the password every time the user requests to access the restricted Web site. This will prove user-friendly.

Next, an example of storing history information on recognition of characters will be described. The storage capacities of human beings are limited. A person is likely to forget a definition of a word or the like and to look up the definition again and again. In such a case, it may be time-consuming and labor-intensive to look up a definition of characters again.

A process of creating the history information and a process of utilizing the history information will be described separately.

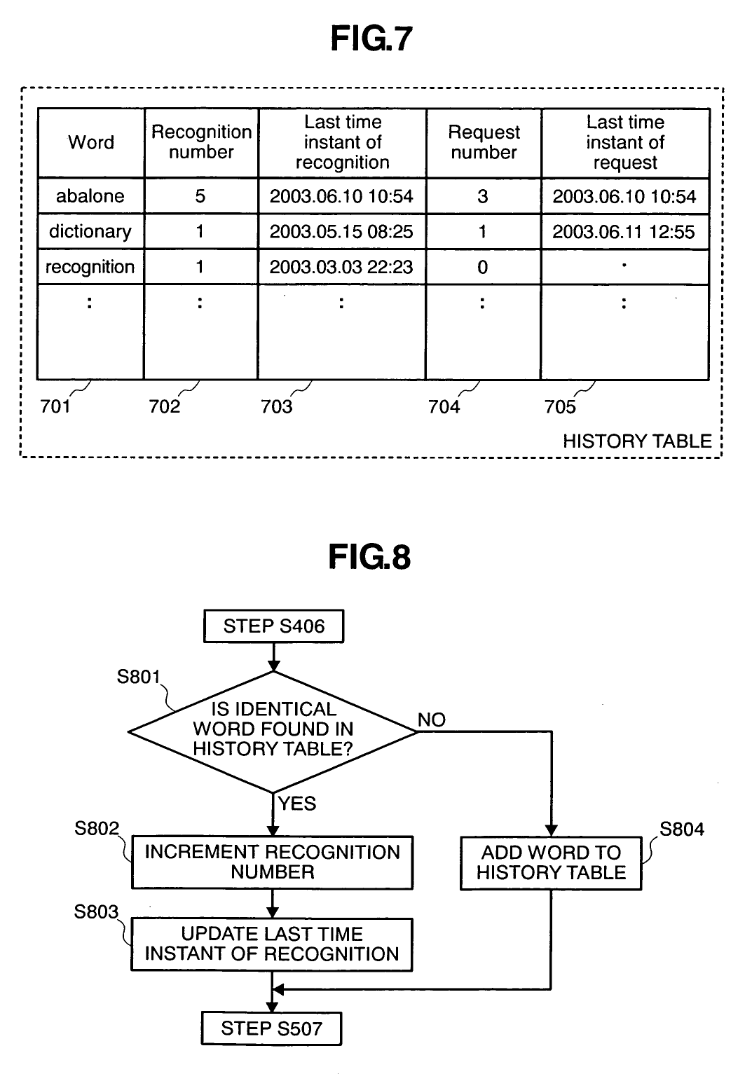

First, the process of creating history information will be described. FIG. 7 shows an example of a history table stored as history information in the memory 104. For example, as shown in FIG. 7, words retrieved by the search unit 109 and time instants at which the words are retrieved are recorded as a history.

In a column 701, words which are recorded in the column 201 of dictionary data and whose characters have been recognized are recorded. In a column 702, a recognition number is recorded. The recognition number is the number of recognition by which each word has been recognized. In a column 703, the latest time instant out of time instants at which each word has been recognized is recorded. In a column 704, a request number is recorded. The request number is the number of requests for detailed information by which the detailed definition of each word have been requested. In a column 705, the time instant at which the detailed definitions of each word have been requested last is recorded.

FIG. 8 is a flowchart describing a process of creating a history table like the one shown in, for example, FIG. 7 after the completion of character recognition executed. Steps S406 and S407 correspond to steps S406 and S407 described in FIG. 4, and steps S801 to S804 are inserted between steps S406 and S407.

At step S406, concise information of the recognized characters contained in the dictionary data 106, that is, typical or simple translations are displayed. Whether the recognized characters such as a word is stored as history information in the memory 104 is verified (step S801). If the word is contained, control is passed to step S802. At step S802, the CPU 102 updates or increments the associated recognition number, which is recorded as history information in the column 702 and by which the word has been recognized. At step S803, the time instant at which the CPU 102 has reached step S803 is recorded as the last recognition time instant, which is history information, in the column 703.

If the word is judged at step S801 not to have been stored as history information, control is passed to step S804. The word and the last recognition time instant are additionally recorded as the history information. As the last recognition time instant, the time instant at which control has reached step S804 is recorded in the column 703. Through the foregoing process, the history table is updated with the history information resulting from the recognition. Preferably, the history information is stored in association with dictionary data stored in the memory 104 so that the history can be used to retrieve the meanings of a word or the like. For example, the history information may be recorded in a part of the dictionary data such as a header.

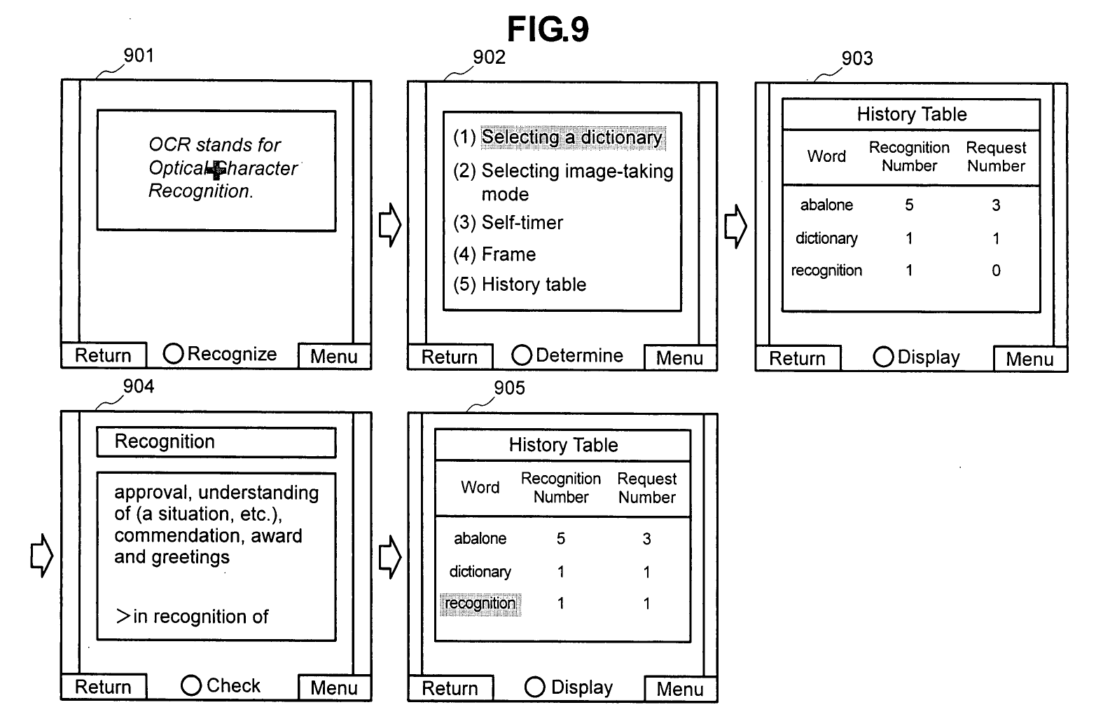

For example, detailed information downloaded via the Internet is stored in the dictionary data 106 if the request number is more than two. If the Last instant of request is more than six months ago, the CPU 102 controls to delete detailed information stored in the dictionary data 106. Next, the process of utilizing created history information will be described. FIG. 9 shows examples of screen images displayed in the course of displaying definitions of words using history information.

With a screen image 901 displayed, a user presses a button associated with Menu appearing in the right lower part of the screen image. Consequently, the screen image 901 is switched to a screen image 902. The screen image 902 helps select any of menu. In this state, if a menu item “(5) History table” is selected, the screen image 902 is switched to a screen image 903. The screen image 903 presents a history table. For example, words, number of recognition by which the words have been recognized, and number of requests by which detailed information related to the words have been request are listed. If one of the displayed words, for example, “recognition” is selected, the screen image 903 is switched to a screen image 904.

The screen image 904 presents detailed information of “recognition.” In this example, the request number for detailed definition of the “recognition” is 0. Therefore, the detailed information is acquired via the Internet. If “abalone” is selected, detailed information is read out from the dictionary data 106 because the request number for detailed definition of the “abalone” is 3.

In this state, if a button associated with Check is pressed, the screen image 904 is switched to a screen image 905. The screen image 905 presents, like the screen image 903, the history table. However, although the request number by which “recognition” has been requested is 0 in the screen image 903, the request number is incremented by one in the screen image 905.

A user can check the meanings of a word, which the user has recognized once, any number of times in any place without the necessity of recognizing the word again. According to this example, a user may acquire detailed information without the Internet access when the user look up same word again and again. Thus, the user-friendliness has improved.

When the screen images like those shown in FIG. 9 are displayed, a user is readily notified of the recognition number and the request number. Furthermore, words the user has looked up many times are identified at sight. If the recognition number and the request number are listed in descending order, the user can identify words which the user could not have memorized readily. This will encourage the user to consciously memorize the words and will prove quite user-friendly.

Moreover, concise information and detailed information may be stored mutually separately as history information in the memory 104. When a user utilizes history information, if the user is allowed to select either a concise information or a detailed information, the user-friendliness would further improve. Incidentally, the history information is not limited to the one shown in FIG. 7. Any information will do as long as the information is concerned with a history.

Moreover, after the CPU executes recognition operation, a user may be notified of whether history information is available. For example, when a result of recognition is displayed, a notification “History Available” or the like may be displayed on the display 107. The notification that a history is available or unavailable is not limited to display of characters, an icon, or a mark but may be given with a sound that is radiated from a loudspeaker or the like. Owing to the notification, the user may know that she/he checked the same word or the like before and may be encouraged to check the history information. This will prove user-friendly.

Moreover, the information processing apparatus may include a position information acquisition unit that is realized with a global positioning system (GPS) or the like. Position information acquired by the position information acquisition unit may be stored as history information in the memory 104. In this case, a place where a word has been recognized can be readily checked. When a user re-visits a place whose name is recorded as history information, the user may be notified of the fact as well as the word recognized in the place and the meanings of the word.

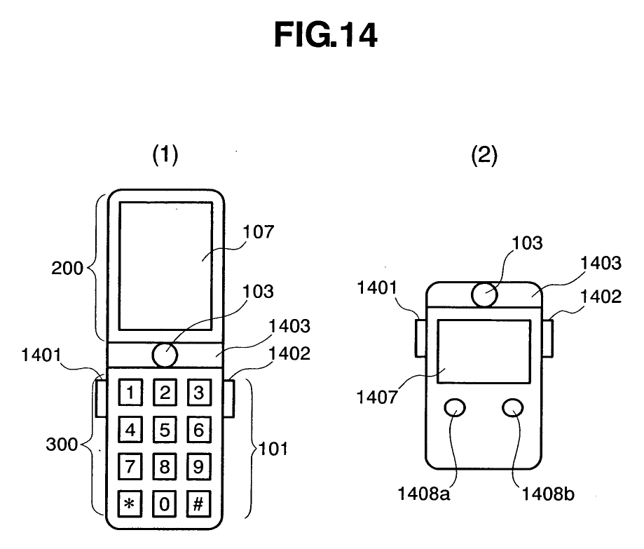

FIG. 14 shows an exemplary appearance of an information processing apparatus. The information processing apparatus can befolded on a hinge 1403 so that a housing 200 including a display 107 and a housing 300 including an input unit 101 will meet each other. The hinge 1403 includes an camera that can be rotated.

The CPU 102 detects whether the portable cellular phone is left open as shown in FIG. 14(1) or left closed as shown in FIG. 14(2). For example, the information processing apparatus a magnet incorporated in the housing 200 and a Hall-effect element incorporated in the housing 300. The CPU 102 detects whether the portable cellular phone is open or closed based on the level of a voltage provided by the Hall-effect element to which a magnetic field is applied by the magnet. The means for detecting is not limited to this example, a sensor such as utilizing engagement of concave and convex members may be used as a fold detection unit.

The information processing apparatus includes, in addition to display 107 used mainly with the information processing apparatus left open, a sub display 1407 that is discernible with the information processing apparatus left folded (closed).

A ordinary image-taking button 1401 and a recognition image-taking button 1402 are formed on, for example, the flank of the housing 300.

When the ordinary image-taking button 1401 is pressed, the camera 104 produces an image of an object of imaging. The produced image is preserved in the memory 104, and displayed if necessary. When the recognition image-taking button 1402 is pressed, the camera 104 produces an image as an object of recognition. After the CPU 102 recognizes characters, the result of recognition is displayed on the display 107 and/or the sub display 1407.

As mentioned above, since the buttons dedicated to the recognition mode and ordinary image-taking mode respectively are included, a user can readily select either of the modes. This will prove user-friendly. Moreover, when the buttons are formed on the flank of the housing 300 as shown in FIG. 14, the buttons are used in the same manner without regard to whether the information processing apparatus is open or closed. This would improve user-friendliness. Furthermore, since the operation keys 1408a and 1408b are, as shown in FIG. 14(2), located as the positions on the flank of the housing 300, a user may operate the information processing apparatus even with the information processing apparatus left closed. This will prove user-friendly.

Incidentally, the ordinary image-taking button 1401 and recognition image-taking button 1402 should preferably be realized with different buttons. However, the ordinary image-taking button 1401 and recognition image-taking button 1402 may be realized with the same button. If the ordinary image-taking button 1401 and recognition image-taking button 1402 are realized with the same button, the way of manipulating the button for imaging and the way of manipulating it for recognition must be different from each other. For example, the ordinary image-taking mode and recognition mode may be switched depending on the time interval during which the button is held pressed or the number of times by which the button is pressed. Moreover, when the same button is used as the ordinary image-taking button and recognition image-taking button, a space may be saved and the information processing apparatusmay be designed compactly. The ordinary image-taking button 1401 and recognition image-taking button 1402 may be realized with any of sensors attached to the portable cellular phone 100 as long as a user can manipulate the buttons.

Although the ordinary image-taking button 1401 and recognition image-taking button 1402 have been described to be formed on the flank of the housing, the present invention is not limited to the structure. As long as the buttons are located at positions at which they can be manipulated with the information processing apparatus left closed, the buttons may be disposed on, for example, the back of the information processing apparatus. In this case, the back of the information processing apparatus is a side that is opposed to the side thereof on which the display 107 is disposed and that is discernible with the information processing apparatus left folded (closed).

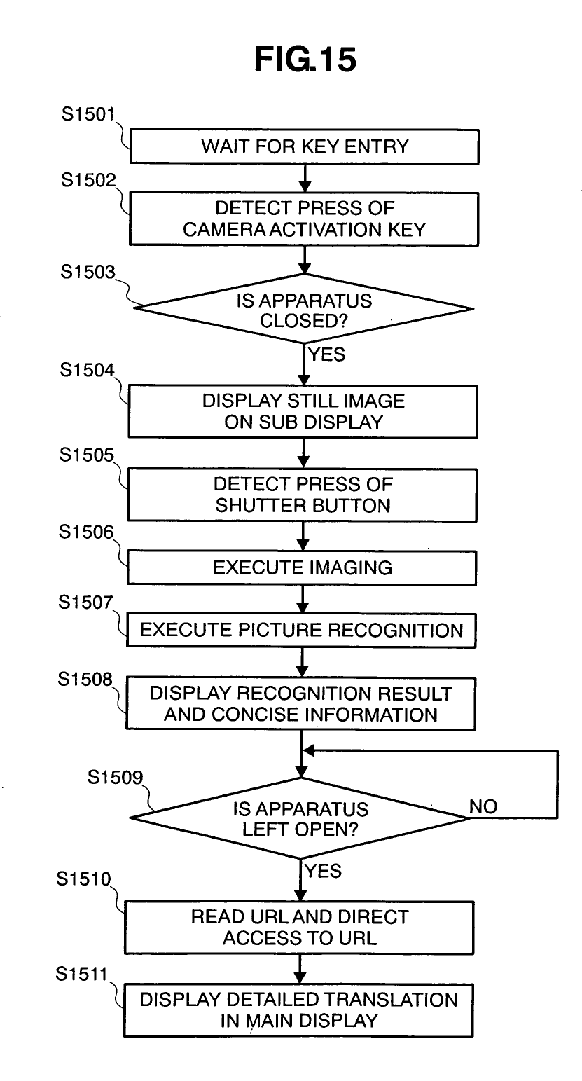

Next, an exemplary procedure to execute picture recognition function when the information processing apparatus is left folded. The procedure will be described in conjunction with the flowchart of FIG. 15.

First, at step S1501, the information processing apparatus is waiting for an entry to be made using the keys included in the input unit 101. When the CPU 102 detects a key entry indicating a request of camera activation (step S1502), the CPU 102 detects whether the information processing apparatus is open or closed (step S1503).

If the information processing apparatus is left folded, the CPU 102 controls display an image on the sub display 1407 (step S1504). In this description, the procedure in which the information processing apparatus is open at the step S1503 is omitted.

When a user presses a shutter button, a signal with which imaging is directed is transferred to the CPU 102 (step S1505). Picture information of an object which is produced (converted) by the camera 103 is preserved in a memory 104 via the CPU 102 (step S1506).

The CPU 102 executes picture recognition operation. Characters contained in the picture information are recognized, and the result of recognition is preserved in the memory 104 (step S1507). The search unit 109 reads the result of recognition, and searches the column 201 in the dictionary data 106 stored in the memory 104 for a consistent word. The result of recognition and concise information of the result are displayed on the sub display 1407 (step S1508).

IF CPU 102 detects that the information processing apparatus is open (step S1509), control is passed to step S1510. The CPU 102 reads a URL associated with the retrieved word from the dictionary data, and transmits a directive signal, with which connection to the URL is directed, via the data communication interface 108 (step S1510). At step S1511, the CPU 102 reads the contents of a home page held at the URL via the data communication interface 108, and displays the contents of the home page on the display 107.

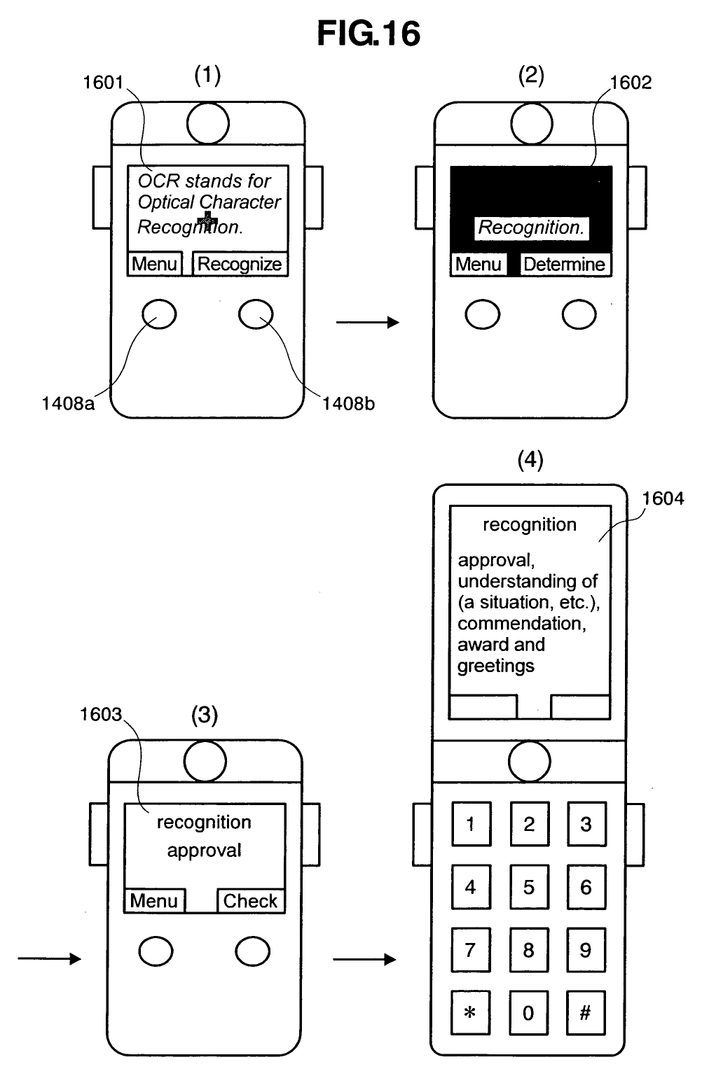

FIG. 16 shows examples of screen images. If a user brings the information processing apparatus form a closed state in which the information processing apparatus is folded to the open state in which the apparatus is not folded, detailed information received via the data communication interface 108 is displayed on the display 107 without a user's key operation. In the screen images 1601 to 1603, an indication “Menu” contained in the left lower parts of the screen images is associated with a button 1408a, and an indication “Recognize” contained in the right lower parts of the screen images is associated with a button 1408b. For example, when “Menu” appears in the left lower part of the screen image, the button 1408a shall be called a Menu button.

A screen image 1601 is an example of a screen image displayed on the sub display 1407 in the recognition mode. IF the button 1408b as a Recognize button is pressed, the screen image 1601 is switched to a screen image 1602.

The screen image 1602 indicates that “Recognition” has been selected as an object of recognition. The part of this screen image other than “Recognition” is painted in black in order to highlight “Recognition.” Moreover, since the part of the screen image other than the characters is painted in black, a misuse of the recognition mode such as stealthy imaging may be prevented. If the button 1408b as a Determine button is pressed, the screen image 1602 is switched to a screen image 1603.

The screen image 1603 presents the result of the recognition and the concise information of the recognized character string. If the portable cellular phone is opened in this state, a screen image 1604 appears on the display 107. The screen image 1604 is an example of a screen image that presents the detailed information of the recognized character strring. As mentioned above, character string can be recognized with the information processing apparatus left folded. The labor of opening the information processing apparatus at every time of character recognition can be saved, and character recognition can be executed readily. Furthermore, when a user wants to know detailed information, if the user opens the information processing apparatus without manipulating the input unit 101, the detailed information is displayed on the display 107. This will prove very user-friendly.

Next, an example of editing a result of recognition will be described. For example, the CPU 102 performs character recognition of “Recognition” written in a paper, if the result of recognition is “Reconifiom”, the result of recognition is edited.

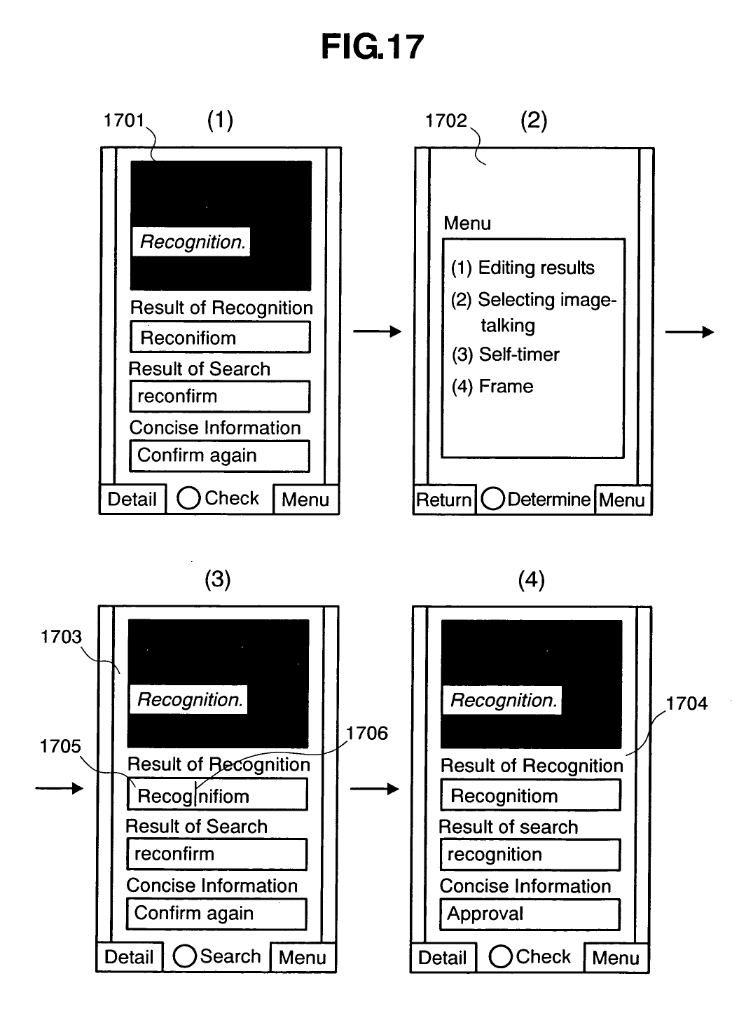

FIG. 17 shows examples of screen images displayed in the course of editing a result of recognition

A screen image 1701 is an example of a screen image displayed on the display 107. In this example, the CPU 102 incorrectly recognizes string of one or more characters “Recognition” as “Reconifiom”. The search unit 109 searches the dictionary data 106 for a word closest to “Reconifiom”, and “reconfirm” is displayed as the result of search. Herein, if a Menu button is pressed, the screen image 1701 is switched to a screen image 1702.

The screen image 1702 presents a menu. Herein, if a menu item “(1) Editing the result” is selected and a Determine button is pressed, the screen image 1702 is switched to a screen image 1703. The screen image 1703 is the screen image helping edit the result of recognition. A cursor 1706 is displayed in a field 1705 in which the result of recognition are displayed. The cursor 1706 is used to select a position at which a character to be edited is located. Using the input unit 101, the characters can be edited. In this example, “m” is deleted, and “g” and “n” are entered. If the Search button is pressed in this state, the search unit 109 searches the dictionary data 106 for a consistent word. Consequently, the consistent word is displayed in a result-of-search field. A screen image 1704 is an example of a screen image that presents the result of search.

As mentioned above, when a result of recognition is incorrect, the CPU 102 need not perform character recognition. For example, when a paper including string of one or more characters is shabby, the CPU may recognize the character string incorrectly even though character recognition is performed again. In this case, the user tries the OCR function again and again. According this example, user may correct the recognition result without executing the OCR function again. This will prove user-friendly.

In the foregoing example, when the Search button is pressed, the search unit 109 searches the dictionary data 106 for a word closest to a result of recognition. Alternatively, the search unit 109 may search for the closest word when one of characters is added or deleted. In this case, a user need not press the Search button every time the user wants to display a result of search. When the recognition result includes plural misrecognized characters, the user may acquire the correct word without editing all of the misrecognized characters. This will prove user-friendly.

Next, an exemplary procedure of transmitting a result of recognition and/or information related to the result to other apparatus will be described. A user manipulates the input unit 101 so as to invoke the mailing function (for example, presses a Run Mailing key) after the recognition result is displayed. The CPU 102 having received the input signal invokes mailing software residing in the memory 104, and displays a mail creation screen image on the display 107 or the display 1407. At this time, the CPU 102 automatically inserts the result of recognition and/or the related information into a text field in the mail creation screen image.

Moreover, a user may select address information (name, telephone number, or mail address) from all the pieces of information stored in the memory 104, and the selected address information may be inserted into a receiving side's address field.

As mentioned above, a user may transmit a result of recognition by performing a simple manipulation. Thus, user-friendliness has improved. Furthermore, if a title name such as “Result of OCR” were automatically inserted into a title field, the labor of entering data would be further saved. The user-friendliness would further improve.

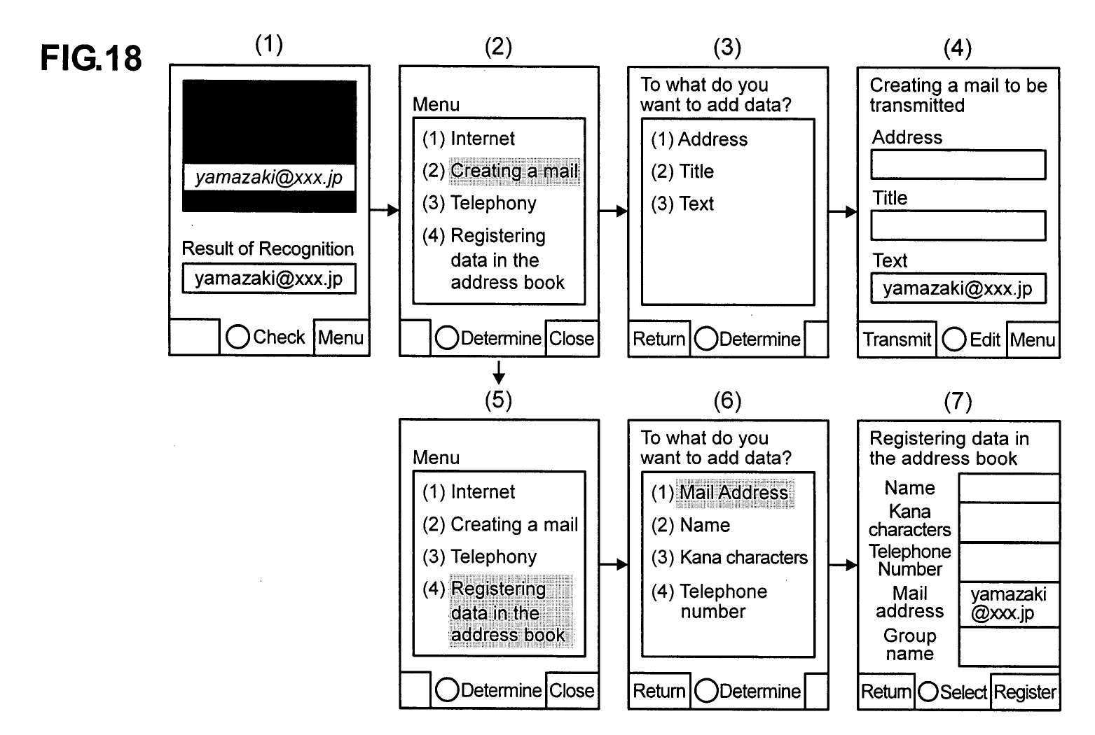

Moreover, if a mail address is recognized, the mail address may be automatically inserted as an address into the address field of the mail creation screen image. Preferably, an editing function is included in the CPU 102 because a user may want to insert the mail address into the text field. The editing function will be described in conjunction with FIG. 18.

A screen image (1) presents a recognition image and a result of recognition. IF the Menu button is pressed, the screen image (1) is switched to a screen image (2). The screen image (2) helps a user select for which of facilities the result of recognition “yamazaki@xxx.jp” will be utilized. When a menu item “(2) Creating a mail” is selected, the screen image (2) is switched to a screen image (3). The screen image (3) helps a user select into which of the fields in a mail creation screen image the result of recognition should be inserted. If a menu item “(3) Text” is selected, the screen image (3) is switched to the mail creation screen image (screen image (4)) in which the result of recognition is assigned to the text of a mail.

As mentioned above, a user can select to which of the portions of a mail a result of recognition is inserted. Consequently, after a screen image presenting the result of recognition is displayed, if several entries are made, the screen image is switched to the mail creation screen image in which the result of recognition is inserted into the text field. Thus, user-friendliness has improved.

Furthermore, when the screen image (2) presenting the menu is displayed, the position of a cursor may be determined based on the kind of character string serving as a result of recognition. Namely, for example, if the result of recognition contains “@,” the CPU 102 regards the result of recognition as a mail address. If the result of recognition contains “http,” the CPU 102 regards the result of recognition as a URL. If the result of recognition is regarded as a mail address, when the screen image (2) is displayed, the cursor is positioned at the menu item “(2) Creating a mail.” If the result of recognition is regarded as a URL, the cursor is positioned at the menu item “(1) Internet.” If the cursor were thus displayed on the display 107, the labor of selecting a menu item in the screen image (2) would be saved. User-friendliness would further improve.

Moreover, when a result of recognition is regarded as a mail address, if a user wants to register the mail address in an address book, the user selects a menu item “(4) Registering in an address book” through the screen image (2). Even in this case, if to which of the fields in the address book the mail address serving as the result of recognition is inserted could be selected, the same advantage as the foregoing one could be provided.

The mail creation screen image provided by mail software has been thought to include the address field, title field, and text field. The present invention is not limited to the structure of the mail creation screen image. Even when any other field may be included, if relevant information were automatically inserted, the labor of making an entry would be saved. This will prove user-friendly.

Moreover, a result of recognition (for example, a URL) has been described to be automatically inserted into any of the fields in the mail creation screen image. Alternatively, a user by himself/herself may be able to enter a comment or the like using the input unit 101. In this case, when a recognition result is transmitted to a called side, a user can transmit not only the result but also a comment or the like on the result. At this time, if any of fixed forms of sentences or pictographs stored in advance in the memory 104 were utilized, user-friendliness would further improve.

This present invention is not limited to a case where a user wants to know the meanings of a word and the examples of use thereof in detail. For example, information on terminology employed in any of various categories such as the categories of sports, movies, histories, restaurants, science, dinosaurs, animals and plants, and entertainers may be able to be offered. In this case, the number of categories relative to which information on terminology is available increases, and user-friendliness improves. When the number of pieces of available information is large, if a user is interested in a certain word while looking over a magazine or a newspaper or walking about and wants to learn the detailed information on the word, the user can immediately acquire the meanings of the word. This will prove quite user-friendly.

Moreover, for example, when a user wants to learn the detailed information on a dinosaur “Gamelan,” if the user acquires the detailed information on a plant “Gamelan,” the user is hardly satisfied. When detailed information is requested, a message saying, for example, “On information of what category do you want to learn detailed information?” may be displayed on the display 107. If a user could select any of various categories through a screen image or the like, user-friendliness would further improve.

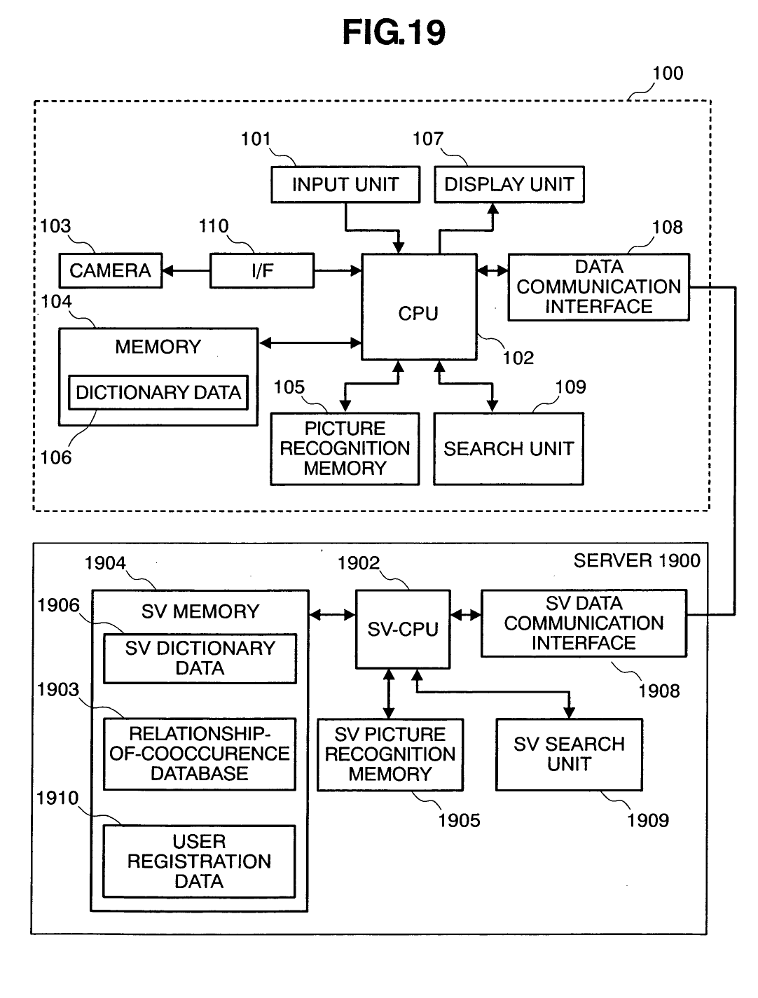

Next, an example utilizing a relationship of co-occurrence between words so as to inform the appropriate meanings of a recognized word will be described below. What is referred to as co-occurrence signifies that a plurality of words appear in the same document. Generally, a word has a plurality of meanings. If a plurality of meanings defined in a dictionary are displayed as it is, a user must read a context and ponder what meaning does a recognized word has in this case. If the word is misinterpreted, a sentence including the word is comprehended incorrectly. This example attempts to cope with this problem. FIG. 19 shows an example of system for searching an appropriate definition.

The server 1900 comprises a server CPU 1902, a relationship-of-co-occurrence database 1903, a server memory 1904, a server picture recognition memory 1905, server dictionary data 1906, a server data communication interface 1908, a server search unit 1909, and a user registration database 1910.

The server data communication interface 1908 performs communication to enable the server 1900 to communicate with servers through a data network such as the Internet. The server CPU 1902 acts based on programs stored in the server memory 1904, and controls the respective components of the server in response to a signal sent via the server data communication interface 1908.

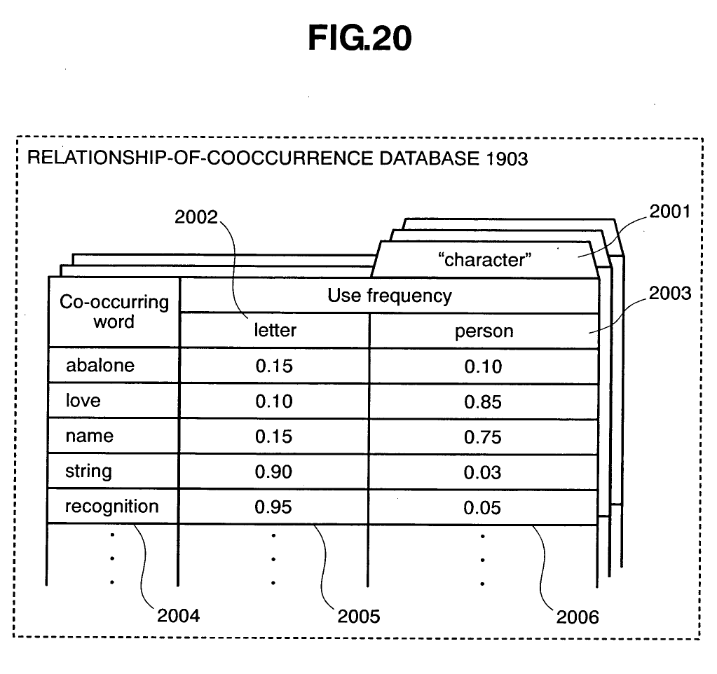

The relationship-of-co-occurrence database contains data representing relationships of co-occurrence. For example, as shown in FIG. 20, the relationship-of-co-occurrence database contains words, definitions of the words, co-occurring words, and percentages at which the definition of each of the words may be used in combination with co-occurring words. Referring to FIG. 20, one of the words is “character,” and the definitions of “character” shall be “letter” and “person.”

The relationship-of-co-occurrence database 1903 holds data items relevant to a plurality of words, and holds the definitions of each of the words and probabilities at which each of the definitions are used in combination with co-occurring words.

If a recognized word co-occurs with other words, the relationship-of-co-occurrence database 1903 is used to compare the probabilities at which the definitions of the word are used in combination with each of co-occurring words, with each other. Consequently, the most appropriate definition of the recognized word can be found out. For example, if “character” and a word “recognition” co-occur, the percentage at which the definition “letter” may be used in combination is 0.95. Moreover, the percentage at which the definition “person” may be used in combination is 0.05. In this case, “letter” that may be used in combination at the high percentage is adopted as the definition of “character.” Data received via the data communication interface and other data to be treated by the server 1900 are stored in the server memory 1904. The server picture recognition memory 1905 is stores a software program to be executed an OCR function by the SV-CPU 1902.

The server dictionary data 1906 stored in the memory 104 contains, for example, plurality of characters such as words, information related to the words such as URLs of home pages each carrying various definitions of the words and the usage and examples thereof, and images or voice concerning the words.

The server search unit 1909 references the relationship-of-co-occurrence database 1903 on the basis of a word and co-occurring words, and selects the appropriate definition of the word.

The user registration database 1901 is a database containing user IDs and passwords based on which users are authenticated as users permitted to access the server 1900.

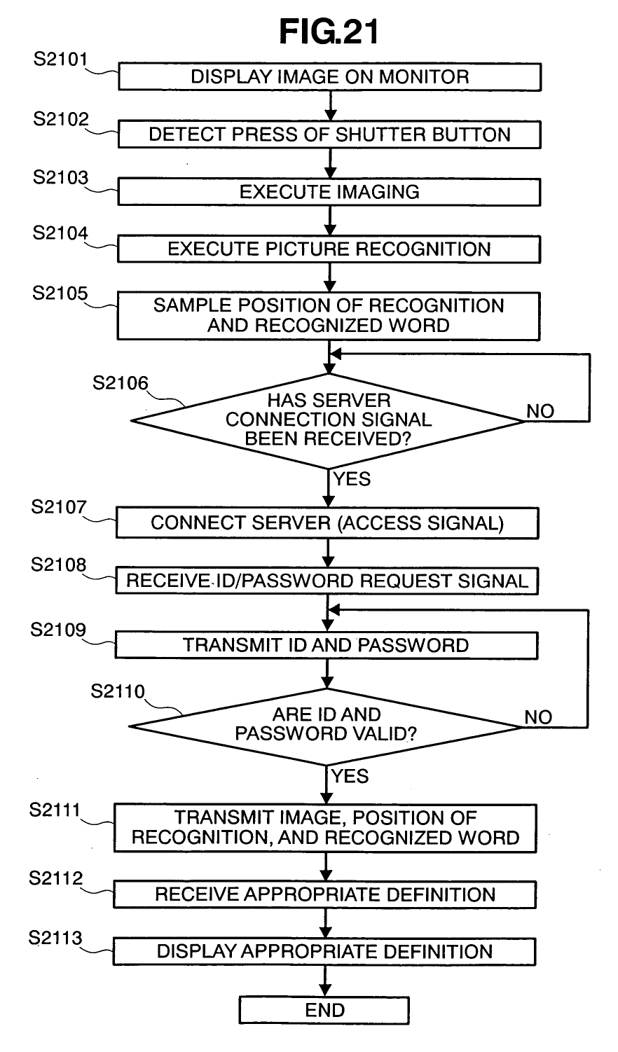

Next, a procedure to be executed in the portable cellular phone in this system will be described in conjunction with the flowchart of FIG. 21.

At step S2101, the display 107 displays image output from the camera 103 as a viewfinder. When the CPU 102 detects the press of the shutter button (step S2102), the camera 103 outputs picture information (step S2103). The CPU 102 executes picture recognition operation (step S2104). At step S2105, a position of recognition and a recognized word are sampled. The position of recognition shall be the position of character, which is an object of recognition, in picture information produced by the camera 103. The recognized word shall be a word retrieved as a result of search performed by the search unit 109 at step S2105.

Thereafter, an access signal with which access to the server 1900 is directed is transferred to the CPU 102 via the input unit 101. The CPU 102 in turn transmits the access signal to a predetermined server via the data communication interface 108 (step S2107).

Thereafter, the server 1900 having received the access signal transmits an entry request signal with which the entry of a user ID and a password associated with the user ID is requested. When the information processing apparatus 100 receives the request signal (step S2108), the CPU 102 displays an entry screen image, through which a user ID and a password are entered, on the display 107. If the user ID and password are entered through the entry screen image, they are transmitted to the server 1900 (step S2109). Herein, a user ID and a password entered by a user are used to authenticate the user. However, the present invention is not limited to this way of authentication as long as authentication of a user can be achieved. For example, a voiceprint, a fingerprint, or the iris may be used for the authentication.

The CPU 102 verifies whether a signal received from the server indicates success or failure in authentication (step S2110). If the signal indicates the failure in authentication, the entry screen image is displayed again on the display 107. If the signal indicates the success in authentication, an image produced by the camera 103, a position of recognition, and a recognized word are transmitted to the server 1900 (step S2111).

Thereafter, when the CPU 102 receives appropriate definition of the recognized word from the server 1900, the CPU 102 displays the appropriate definition on the display 107 (step S2112 and step S2113).

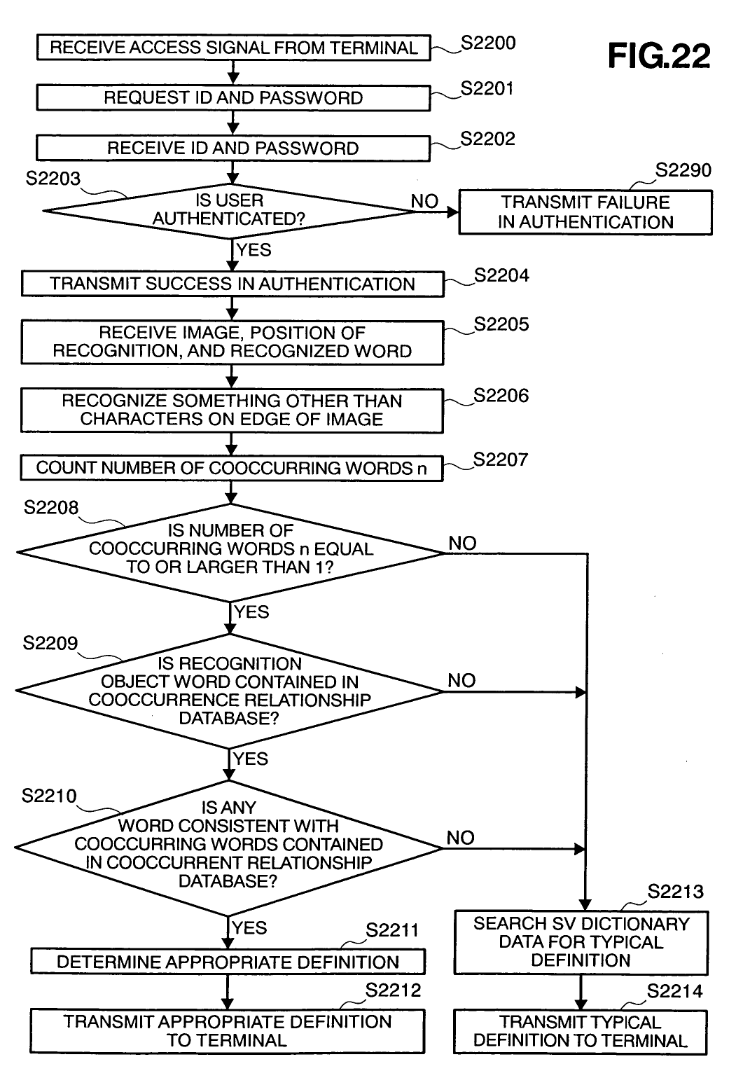

Next, referring to the flowchart of FIG. 22, a procedure to be executed in the server 1900 in this system will be described below.

When the server 1900 receives an access signal from the information processing apparatus 100 (step S2201), the server requests the information processing apparatus 100 for input of a user ID and a password (step S2201). When the user ID and password are received from the information processing apparatus 100 (step S2202), the server CPU 1902 references the user registration data 1910. If the received user ID and password are consistent with a user ID and a password contained in the user registration data 1910, the server CPU 1902 notifies the information processing apparatus 100 via the server data communication interface 1908 that the user has been authenticated (step S2204). An image, a position of recognition, and a recognized word are then received from the information processing apparatus 100 (step S2205).

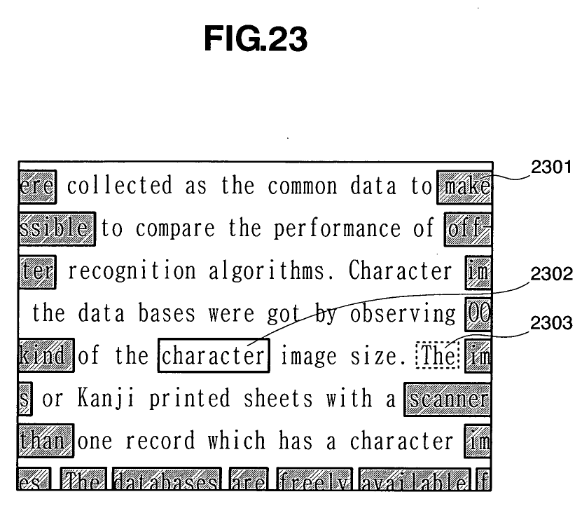

Thereafter, the server CPU 1902 recognizes characters contained in a received image. FIG. 23 shows an example of the received image. During recognition, the SV-CPU 1902 samples all the words contained in the image, and identifies a position of recognition. Words that are truncated with the sides of a sampling domain are not regarded as objects of recognition.

In the example of the image shown in FIG. 23, hatched words including a word 2301 are not regarded as objects of recognition. The other words such as a word 2303 “The” that are not truncated with the sides of the sampling domain are recognized. The server search unit 1909 searches the server dictionary data 1906 for words consistent with or closest to the recognized words (step S2206).

Thereafter, the number n of co-occurring words of the recognition object word is counted (step S2207). The recognition object word is identified based on the position of recognition and recognized word received from the information processing apparatus. At step S2208, if the number n of co-occurring words is one or more, whether the recognition object word is contained in the relationship-of-co-occurrence database 1903 (step S2209). If the recognition object word is contained therein, whether words consistent with the co-occurring words are contained in the column 2004 within the relationship-of-co-occurrence database 1903 (step S2210).

If the words consistent with the co-occurring words are contained in the relationship-of-co-occurrence database 1903, the most appropriate definition is determined for the recognition object word (step S2211).

For the determination, probabilities at which each of the definition of the recognition object word may be used in combination with the co-occurring words contained in the relationship-of-co-occurrence database 1903 are calculated. For example, assume that the recognition object word is “character” and the co-occurring words are “string” and “recognition.” In this case, if “string” co-occurs with “character,” the percentage at which the definition “letter” may be used in combination with “string” is 0.90. If “recognition” co-occurs with “character,” the percentage at which the definition “letter” may be used in combination with “recognition” is 0.95. The sum of these percentages is 1.85. Moreover, the sum of the percentages at which the definition “person” may be used in combination with “string” and “recognition” respectively is 0.08. The definition maximizing the sum can be adopted as the most appropriate definition. In this case, the percentages are summated in order to determine the appropriate definition. However, the present invention is not limited to this method. Alternatively, the appropriate definition may be determined through a combination of multiplication and division or subtraction. Finally, the appropriate definition is transmitted to the information processing apparatus (S2212).

If the number n of co-occurring words is judged to be 0 at step S2208, control is passed to step S2213. A typical definition is retrieved from the server dictionary data 1906, and transmitted to the information processing apparatus at step S2214.

Moreover, if the recognition object word is judged at step S2209 not to be contained in the relationship-of-co-occurrence database 1903 or if words consistent with the co-occurring words are judged at step S2210 not to be contained in the relationship-of-co-occurrence database 1903, control is passed to step S2213. A typical definition is transmitted to the information processing apparatus.

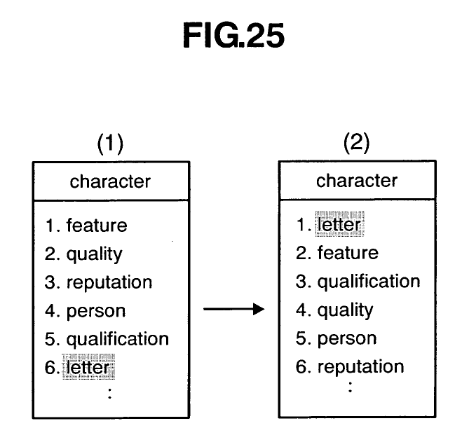

According to the foregoing procedure, the appropriate definition is determined at step S2211. Alternatively, a plurality of definitions may be determined. For example, the six largest values of the sum of percentages at which a word is used in combination with co-occurring words are calculated. This data shall be called definition display sequence data. FIG. 25(1) shows the definitions of “character” that are not sorted, while FIG. 25(2) shows the definitions thereof that are sorted by appropriateness.

The definitions are transmitted to the information processing apparatus in the form of the definition display sequence data. The CPU 102 controls so that the definitions will be displayed on the display 107 based on the translation display sequence data.

Consequently, a user can learn the definition of the recognition object word. Moreover, the user readily learns which of the definition the recognition object word is likely to have in a certain context. This will prove user-friendly.

Moreover, the appropriate definition selected by the server 1900 may be incorrect. Even in this case, as shown in FIG. 25, not only the appropriate definition but also other definitions are listed orderly. This will greatly help a user judge the definition of a word from a context.

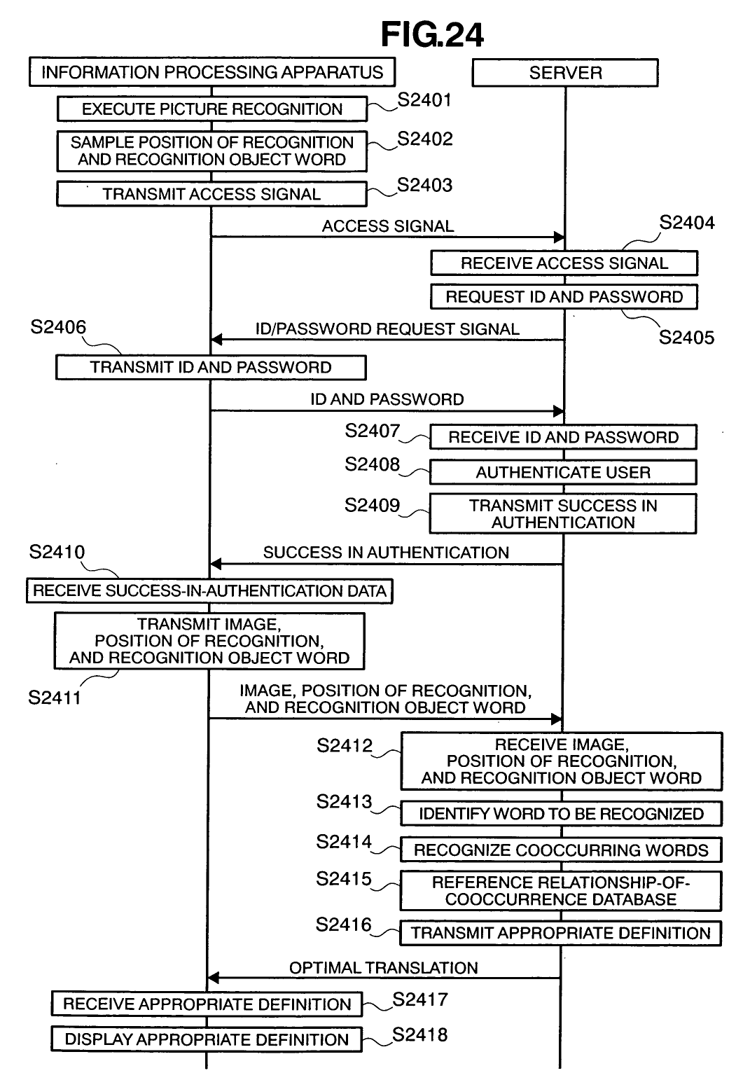

FIG. 24 shows an exemplary sequence of transactions performed by the information processing apparatus and the server. As has been described, The CPU 102 executes character recognition(step S2401), and samples data representing a recognition object word and data representing a position of the recognition object word (step S2402). Thereafter, a user uses the input unit 101 to direct acquisition of the detailed information of the recognition object word. The CPU 102 transmits an access signal with which the information processing apparatus is connected to the server (step S2403).

In response to the access signal, the server transmits an ID/password request signal, with which a user ID and a password are requested, to the information processing apparatus (step S2404 and step S2405). In response to the ID/password request signal, the CPU 102 control to transmit a user ID and a password via the data communication interface 108, which the user has entered through the entry screen image or the like, to the server (step S2406).

Thereafter, the server checks the received user ID and password so as to judge whether the user is an authentic registrant. If the result of the judgment demonstrates that the user is an authentic registrant (valid), the server 1900 transmits data representing a success in authentication. If the user is not regarded as an authentic registrant (invalid), the server 1900 transmits data representing a failure in authentication (step S2407 to step S2409). Herein, assume that authentication is valid.

The information processing apparatus having received a success in authentication transmits a produced image as well as the recognition object word and the position of the recognition object word, which are contained in the image, to the server (step S2410 and step S2411).

The server having received the image, the recognition object word, and the position of the recognition object word identifies, as mentioned previously, the recognition object word contained in the image (step S2413). Co-occurring words of the recognition object word are sampled (step S2412 to step S2414). Thereafter, the relationship-of-co-occurrence database held in the server is referenced in order to transmit data, which represents the appropriate definition of the recognition object word, to the information processing apparatus (step S2415 and step S2416).

The information processing apparatus displays the appropriate definition on the display 107 (step S2417 and step S2418).

Consequently, a user can acquire the appropriate definition of a certain word that matches a context. This will prove user-friendly. Moreover, the server normally superior to the information processing apparatus in terms of a throughput and a storage capacity has the relationship-of-co-occurrence database stored in the memory thereof, and incurs the load of determining an optimal translation using the database. Consequently, the load of processing the portable cellular phone has to incur and the storage capacity the portable cellular phone has to offer can be alleviated or reduced. Eventually, a system well-balanced in terms of the throughput and storage capacity can be realized. However, the present invention is not limited to this example, the information processing apparatus may have relationship-of-co-occurrence database and search an appropriate definition without the connection to the server.

Furthermore, if a server like the aforesaid one that processes information is used to provide an appropriate definition service or the like, a steady income can be earned monthly. This is effective from an economical viewpoint.

Moreover, instead of providing the service for users free or at a low cost, a contract may be made with an advertising agent and an income may be earned as advertising expenditures. In this case, the server appends an advertisement to an appropriate definition, and transmits the appropriate definition to the information processing apparatus. The information processing apparatusmay display the appropriate definition together with the advertisement. At this time, the server also transmits position data so that the advertisement and appropriate definition will not overlap when being displayed. Based on the position data, the information processing apparatus displays the advertisement and appropriate definition. Consequently, a user can discern the appropriate definition and advertisement that are neither overlapping nor coexisting.

It is also worth noting that the software to be executed for implementing functions of the examples described above does not have to be stored in the memory of the information processing apparatus in advance. Instead, the software can be installed in the information processing apparatus by using the Internet or a recording medium after the user purchases the information processing apparatus. In this case, it is not necessary to newly purchase another information processing apparatus. Since new functions can be added to the purchased information processing apparatus, the cost can be reduced.

The term “recording medium” as used herein refers to any medium that participates in implementing the processing. Such a medium may take many forms, including but not limited to, non-volatile media, volatile media, and transmission media. Non-volatile media include, for example, optical or magnetic disks. Volatile media include dynamic memory. Transmission media may include coaxial cables; copper wire and fiber optics, as well as electric, electromagnetic or light signals that transit such physical links. Transmission media can also take the form of electric or electromagnetic signals, or acoustic or light waves such as those generated during radio frequency and infrared wireless data communications. Common forms of machine-readable media include, for example, a floppy disk, a flexible disk, hard disk, magnetic disk, magnetic tape, any other magnetic medium, a CD-ROM, DVD, any other optical medium, a RAM, a PROM, and EPROM, a FLASH-EPROM, any other memory chip or cartridge, a carrier wave transporting data or instructions.

Moreover, the present invention is not limited to the aforesaid examples. The disclosed principles and novel properties encompass a wide range of technologies. Furthermore, the aforesaid exmples may be combined.

1. An information processing apparatus comprising
a camera that outputs picture information;
a memory which stores concise information related to at least one string of one or more characters;
a data communication interface for communication via a network; and
a CPU which recognizes a string of one or more characters included in picture information output by the camera and displays a result of recognition and concise information related to the recognized string in response to a character recognition request by a user, and controls the data communication interface to communicate via the network and displays additional information received by the data communication interface when the user requests detailed information related to the recognized string.

2. The information processing apparatus according to claim 1, wherein the memory stores access information for communication via a network, and the data communication interface communicates via a network based on the access information stored in the memory when the user requests detailed information.

3. The information processing apparatus according to claim 1, wherein the user requests the character recognition by manipulating a shutter button.

4. The information processing apparatus according to claim 2, wherein the access information includes an address of a home page.

5. The information processing apparatus according to claim 2, wherein the access information includes an ID or a password for communication via a network.

6. The information processing apparatus according to claim 1, further comprising: a picture recognition memory which stores character patterns for comparison in picture recognition by the CPU.

7. The information processing apparatus according to claim 6, wherein the picture recognition memory stores character patterns received by the data communication interface.

8. The information processing apparatus according to claim 1, wherein the memory stores history data including at least one of number of recognition performance, number of the user request for detailed information and the latest time of the recognition or the request for detailed information.

9. The information processing apparatus according to claim 1, wherein the memory stores the detailed information received by the data communication interface when number of the user requests for detailed information achieves a predetermined value.

10. The information processing apparatus according to claim 9, wherein the memory deletes the detailed information when the latest time of the user request for detailed information is a predetermined period ago.

11. The information processing apparatus according to claim 1, wherein the CPU includes a mail transmit function to transmit a mail to another device via the data communication interface, and controls the data communication interface to transmit an email including the result of the recognition or the concise information when an activation request for a mail transmit function is input by the user after the result is displayed.

12. The information processing apparatus according to claim 1, wherein the additional information is related to the recognized string.

13. The information processing apparatus according to claim 1, wherein the additional information is detailed information related to the recognized string.

14. The information processing apparatus according to claim 13, wherein the recognized string is a word and the detailed information is a dictionary data including a definition of the word.

15. The information processing apparatus according to claim 14, wherein the dictionary data includes a usage of the word.

16. The information processing apparatus according to claim 1, wherein the recognized string is a word, the concise information is concise definition of the word and the additional information is detailed definition of the word.

17. An information processing apparatus comprising
a picture interface which inputs picture information into the information processing apparatus;
a memory which stores first information related to at least one string of one or more characters;
a data communication interface for communication via a network; and
a CPU which recognizes a string of one or more characters included in picture information input by the picture interface and displays a result of recognition and first information related to the recognized string in response to a character recognition request by a user, and controls the data communication interface to communicate via the network and displays second information received by the data communication interface when the user requests more information related to the recognized string.

18. An information processing apparatus including a first housing and a second housing, and capable of being folded so that the first housing and the second housing will meet each other, comprising:
a picture interface which inputs picture information into information processing apparatus;
a memory which stores information related to at least one string of one or more characters;
a data communication interface for communication via a network;
a fist display located at a position where the first display is visible in an open state in which the information processing apparatus is not folded;
a second display located at a position where the second display is visible in a closed state in which the information processing apparatus is folded; and
a CPU which recognizes a string of one or more characters included in picture information input by the picture interface and displays a result of recognition and information related to the recognized string on the second display in response to a character recognition request by a user in the closed state, and controls the data communication interface to communicate via the network and displays additional information received by the data communication interface on the first display when the user changes the information processing apparatus from the closed state to the open state.

19. The information processing apparatus according to claim 18, further comprising a camera which outputs picture information, wherein the picture information output by the camera is input into the picture interface.

20. An information processing method comprising the steps of:
storing first information related to at least one string of one or more characters;
recognizing a string of one or more characters included in received picture information in response to a character recognition request by a user;
displaying a result of recognition and first information related to the recognized string;
communicating via a network to obtain second information when the user requests more information related to the recognized string of one or more characters;
displaying the second information received via the network.

21. The information processing method according to claim 20, wherein the first information is concise information related to the recognized string and the second information is detailed information related to the recognized string.

22. A method for controlling an information processing apparatus including a first housing and a second housing, and capable of being folded so that the first housing and the second housing will meet each other, comprising the steps of:
storing first information related to at least one string of one or more characters;
recognizing a string of one or more characters included in received picture information in response to a character recognition request by a user if the information processing apparatus is folded;
displaying a result of recognition and first information related to the recognized string of one or more characters on a second display located at a position where the second display is visible in a closed state in which the information processing apparatus is folded;
communicating via the network to obtain second information when the user changes the information processing apparatus from the closed state to a open state in which the information processing apparatus is not folded; and
displays the second information received by the data communication interface on the first display located at a position where the first display is visible in the open state.

23. A software product comprising executable programming code, wherein execution of the programming code causes an information processing apparatus to implement a series of steps, comprising:
storing first information related to at least one string of one or more characters;
recognizing a string of one or more characters included in received picture information in response to a character recognition request by a user;
displaying a result of recognition and first information related to the recognized string of one or more characters;
communicating via the network to obtain second information when the user requests more information related to the recognized string of one or more characters;
displaying the second information received via the network.

24. A software product comprising executable programming code, wherein execution of the programming code causes an information processing apparatus to implement a series of steps, wherein the information processing apparatus includes a first housing and a second housing and is capable of being folded so that the first housing and the second housing will meet each other, the series of the steps comprising:
storing information related to at least one string of one or more characters;
recognizing a string of one or more characters included in received picture information in response to a character recognition request by a user if the information processing apparatus is folded;
displaying a result of recognition and information related to the recognized string of one or more characters on a second display located at a position where the second display is visible in a closed state in which the information processing apparatus is folded;
communicating via the network to obtain additional information when the user changes the information processing apparatus from the closed state to a open state in which the information processing apparatus is not folded; and
displays the additional information received by the data communication interface on the first display located at a position where the first display is visible in the open state.

25. An Information processing system comprising an information processing apparatus and a server;
the information processing apparatus comprising:
a picture interface which inputs picture information into the information processing apparatus;
a first data communication interface for communication with the server; and
a first CPU which recognizes a word included in picture information input by the picture interface in response to a character recognition request by a user, controls the first data communication interface to transmit data including the recognized word and a co-occurrence word of the recognized word to the server when a user requests information related to the recognized word, and displays information received by the first data communication interface;
the server comprising:
a second data communication interface for communication with the information processing apparatus;
a memory which stores a plurality of information associated with words and co-occurrence words,
a second CPU which reads out at least one item of information based on the data transmitted from the information processing apparatus from the memory, and controls the second data communication interface to transmit the information to the information processing apparatus for display.
